(19) United States
(12) Patent Application Publication
(10) Pub. No.: US 2026/0222581 A1
(43) Pub. Date: Jul. 30, 2026

(54) CODING PARAMETER DETERMINING METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Zhicheng LI, Shenzhen (CN)

(73) Assignee: TENCENT TECHNOLOGY (SHENZHEN) COMPANY LIMITED, Shenzhen (CN)

(21) Appl. No.: 19/643,895

(22) Filed: Apr. 10, 2026

Related U.S. Application Data
(63) Continuation of application No. PCT/CN2024/136876, filed on Dec. 4, 2024.

(30) Foreign Application Priority Data
Jan. 15, 2024 (CN) 202410052407.2

(51) Int. Cl. H04N 19/136; H04N 19/154; H04N 19/172

(52) U.S. Cl. CPC H04N 19/136; H04N 19/154; H04N 19/172

(57) ABSTRACT

A coding parameter determining method, apparatus, and computer-readable storage medium for efficient video recoding. The method parses a bit stream to obtain a coded picture and decoding information, then decodes the coded picture using the decoding information to produce a reconstructed picture. Based on decoding parameters contained in the decoding information, coding parameters are determined for recoding the reconstructed picture. The reconstructed picture is then recoded using these determined coding parameters to generate a recoded bit stream. This approach enables intelligent recoding by leveraging decoding parameters from the original encoding process to inform recoding decisions, facilitating efficient video transcoding and format conversion operations.

### CROSS-REFERENCE TO RELATED APPLICATIONS

This application is a continuation application of International Application No. PCT/CN2024/136876 filed on December 4, 2024 which claims priority to Chinese Patent Application No. 202410052407.2, filed with the China National Intellectual Property Administration on January 15, 2024, the disclosures of each being incorporated by reference herein in their entireties.

### FIELD

The disclosure relates to the technical field of coding and decoding, a coding parameter determining method and apparatus, an electronic device, and a storage medium.

### BACKGROUND

Scenarios such as live streaming, real-time communication (RTC), cloud rendering, and cloud desktop all have relatively high requirements on the frame output stability of a video coding kernel.

Usually, computing resources consumed by the video coding kernel are related to the complexity of a video image.

For example, static images or images with low motion texture are relatively easy to compress, and consume relatively few computing resources. However, the compression of images with a relatively complex motion texture consumes relatively more computing resources. If an image texture of a compressed video is relatively complex, and scene switching is relatively frequent, computing resources consumed in video coding compression may fluctuate significantly.

However, when the computing resource fluctuates significantly, the central processing unit (CPU) consumption of a server may fluctuate significantly. When the CPU consumption fluctuates significantly, the frame output stability may be affected, and especially for scenarios such as live streaming, RTC, cloud rendering, and cloud desktop, the deployment costs of the server may also increase. The reason is that a relatively large number of computing resources need to be reserved as buffer space for computing resource orchestration and scheduling, so as to handle fluctuations of the computing resources during the scene switching of a video image. For example, when a server runs 10 live video coding streams simultaneously, the CPU utilization may be controlled to be 50% or below to the greatest extent during scheduling. This prevents server computing resource overload caused by simultaneous surges in computing resource consumption when all 10 video coding streams switch to complex texture scenes, thereby ensuring the frame output stability in video coding.

Therefore, reducing fluctuations in consumption of computing resources to improve the frame output stability of a coding kernel and reduce the deployment costs of a server is a technical problem that urgently may be solved in the art.

### SUMMARY

Provided are a coding parameter determining method and apparatus, a device, a storage medium, and a program product, which can implement efficient video recoding through decoding parameter-based coding parameter determination and reconstructed picture processing.

According to some embodiments, a coding parameter determining method, performed by a computer device, includes: parsing a bit stream to obtain a coded picture and decoding information; decoding the coded picture using the decoding information to obtain a reconstructed picture; determining, based on a decoding parameter in the decoding information, a coding parameter for recoding the reconstructed picture; and recoding the reconstructed picture based on the coding parameter to generate a recoded bit stream.

According to some embodiments, a coding parameter determining apparatus, includes: at least one memory configured to store program code; and at least one processor configured to read the program code and operate as instructed by the program code, the program code including: parsing code configured to cause at least one of the at least one processor to parse a bit stream to obtain a coded picture and decoding information; decoding code configured to cause at least one of the at least one processor to decode the coded picture using the decoding information to obtain a reconstructed picture; determining code configured to cause at least one of the at least one processor to determine, based on a decoding parameter in the decoding information, a coding parameter for recoding the reconstructed picture; and recoding code configured to cause at least one of the at least one processor to recode the reconstructed picture based on the coding parameter to generate a recoded bit stream.

According to some embodiments, a non-transitory computer-readable storage medium, storing computer code which, when executed by at least one processor, causes the at least one processor to at least: parse a bit stream to obtain a coded picture and decoding information; decode the coded picture using the decoding information to obtain a reconstructed picture; determine, based on a decoding parameter in the decoding information, a coding parameter for recoding the reconstructed picture; and recode the reconstructed picture based on the coding parameter to generate a recoded bit stream.

### BRIEF DESCRIPTION OF THE DRAWINGS

To describe the technical solutions of some embodiments more clearly, the following briefly introduces the accompanying drawings required for describing the embodiments. Apparently, the accompanying drawings in the following description show only some embodiments of this application, and a person of skill in the art may still derive other drawings from these accompanying drawings without creative efforts.

FIG. 1 is a schematic block diagram of a video coding and decoding system according to some embodiments.

FIG. 2 is a schematic block diagram of a video coder according to some embodiments.

FIG. 3 is a schematic structural diagram showing a relationship between a coding tree unit and a coding unit provided in this application.

FIG. 4 is a schematic block diagram of a video decoder according to some embodiments.

FIG. 5 is a schematic diagram of partition modes of PUs and TUs according to some embodiments.

FIG. 6 is a schematic diagram showing the principle of motion estimation according to some embodiments.

FIG. 7 is a schematic diagram showing the principle of motion compensation according to some embodiments.

FIG. 8 is a schematic flowchart of a coding parameter determining method according to some embodiments.

FIG. 9 is another schematic flowchart of a coding parameter determining method according to some embodiments.

FIG. 10 is a schematic diagram of using a decoding parameter in a coding kernel according to some embodiments.

FIG. 11 is a schematic block diagram of a coding parameter determining apparatus according to some embodiments.

FIG. 12 is a schematic block diagram of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of skill in the art without creative efforts shall fall within the protection scope of the present disclosure.

In the following descriptions, related "some embodiments" describe a subset of all possible embodiments. However, it may be understood that the "some embodiments" may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The technical solutions in the embodiments of the present disclosure will be clearly and completely described below with reference to accompanying drawings in the embodiments of the present disclosure. Apparently, the described embodiments are merely some rather than all of the embodiments provided in this application. All other embodiments obtained by a person of skill in the art based on some embodiments without creative efforts shall fall within the protection scope of this application.

The solutions provided in this application relate to the field of digital compression technology.

Digital video compression technology mainly involves compressing large amounts of digital video data, so as to facilitate transmission, storage, and the like.

The solutions provided in this application may be applied to the field of digital video coding technology.

The field of digital video coding technology includes, but is not limited to, at least one of the following: the field of picture coding and decoding, the field of video coding and decoding, the field of hardware video coding and decoding, the field of dedicated circuit video coding and decoding, and the field of real-time video coding and decoding. In addition, the solutions provided in this application may be combined with the following standards: audio video coding standard (AVS), the second-generation AVS standard (AVS2), or the third-generation AVS standard (AVS3). For example, these standards include, but are not limited to, the H.264/audio video coding (AVC) standard, the H.265/high efficiency video coding (HEVC) standard, and the H.266/versatile video coding (VVC) standard. In addition, the solutions provided in this application may be used for performing lossy compression on pictures, or may be used for performing lossless compression on pictures. The lossless compression may be visually lossless compression, or may be mathematically lossless compression.

For ease of understanding the technical solutions provided in this application, related terms will be described below.

Instantaneous decoding refresh (IDR) frame: In a video coding algorithm, pictures are organized in units of sequences. A first picture in a sequence is referred to as an IDR frame, and IDR pictures are each an I-frame. The IDR frame is also referred to as an IDR picture.

I-frame: An IDR frame may cause a reference frame list (decoded picture buffer, DPB) to be cleared, while an I-frame does not. The IDR picture is necessarily an I-frame, but the I-frame is not necessarily an IDR frame. There may be many I-frames in a sequence, and frames following an I-frame may reference frames between I-frames for motion reference.

P-frame: A forward predictive coded frame. The P-frame represents a difference between a current frame and a previous key frame (or a P-frame), and a difference defined in the current frame may be added to a previously cached image during decoding to generate a final image.

B-frame: A bidirectional predictive interpolated coded frame. The B-frame is a bidirectional difference frame. In other words, the B-frame records a difference between a current frame and previous and subsequent frames. The B-frame may be used as a reference frame for other B-frames, or may not be used as the reference frame for other B-frames.

Quantization parameter (QP): A bit rate control algorithm mainly involves outputting a target bit rate by adjusting quantization parameters of discrete cosine transform. Actually, the quantization parameter (QP) reflects the compression level of spatial details. If the QP is small, most of the details are reserved. If the QP increases, some details are lost, the bit rate is lowered, the picture distortion is worse, and the quality is reduced. That is, the QP and the bit rate have an inverse relationship, and the inverse relationship becomes more pronounced as complexity of a video source increases.

Intra-frame prediction: A predicted block is a block formed based on a coded reconstructed block and a current block.

Inter-frame prediction: It mainly includes motion estimation (motion search method, motion estimation criteria, sub-pixel interpolation, and motion vector estimation) and motion compensation, and is temporal reference and prediction interpolation compensation at the granularity of groups of pictures (GOPs).

Sum of absolute difference (SAD): The sum of absolute difference values.

Sum of absolute error (SAE): The sum of absolute errors.

Sum of absolute transformed difference (SATD): The sum of absolute values after applying a transform, such as the Hadamard transform.

Motion compensation (MC): It reduces the data volume between consecutive pictures by predicting a motion trajectory of an object in a picture and compensating for the displacement of the object.

Motion estimation (ME): It removes redundant information in the time dimension by searching for a correlation between neighboring pictures and computing a motion vector between blocks, thereby further improving the compression efficiency.

Lookahead: It performs coding cost estimation on a picture that has not been analyzed, buffers a specified number of reconstructed pictures that have been coded before a current picture, and performs inter-frame prediction reference evaluation for the current picture. In other words, before picture data is actually coded, a certain number of pictures are analyzed in advance, and the subsequent coding process is guided by applying the lookahead data.

Bjøntegaard Delta-rate (BD-rate): One of the main parameters for evaluating the performance of video coding algorithms. It represents the bit rate and peak signal-to-noise ratio (PSNR) differences between a video coded with a new algorithm and a video coded with an original algorithm.

Group of pictures (GOP): An interval between two I-frames.

Mini-GOP: Within a GOP, there are a certain number of B-frames between two P-frames, and the interval between two P-frames is a mini-GOP.

Rate distortion optimization (RDO): Many modes are available for selection in the coding process, and some modes produce relatively low picture distortion but a very high bit rate, and some modes produce relatively high picture distortion but a very low bit rate. Based on the above, the distortion may be minimized without exceeding a maximum bit rate. In the rate distortion optimization of video coding, the maximum bit rate may be used as a constraint condition and distortion may be used as an optimization target, and then an optimal coding parameter is searched using the Lagrange multiplier method.

Macroblock: The unit of coding, and a picture is first partitioned into macroblocks before processing. For example, a picture may be partitioned into macroblocks in units of a size (16×16 in H.264), and coding is performed in blocks (for example, a macroblock or blocks obtained by partitioning a macroblock) in the coding process.

Reference picture: In video coding and decoding, it represents a reconstructed picture used as reference data of other pictures and configured for acquiring inter-picture reference data of other pictures in the coding/decoding process.

Motion vector (MV): A two-dimensional vector, configured for describing the position offset that occurs when a coding block in a coder moves from its original position to another position.

Motion search (MS): A process in which a current coding block searches for an optimal matching block in a reference picture according to an algorithm.

Motion vector prediction (MVP): A prediction performed on a current MV based on existing information according to an algorithm.

The terms used in the implementations of this application are merely intended to explain some embodiments, and are not intended to limit this application.

For example, the term "and/or" herein merely describes an association relationship between associated objects and represents that three relationships may exist. For example, A and/or B may represent the following three cases: only A exists, both A and B exist, and only B exists. The term "at least one" merely describes a combination relationship among listed objects, represents that one or more items may exist (for example, at least one of the following: A, B, and C), and may represent the following combination cases: only A exists, only B exists, only C exists, both A and B exist, both A and C exist, both B and C exist, and both A, B, and C exist. The term "a plurality of" means two or more. The character "/" generally indicates an "or" relationship between associated objects.

For another example, the term "correspond" may represent that there is a direct or indirect correspondence between the two, or may represent that there is an association relationship between the two, or may represent that there is a relationship such as indication and being indicated, or configuration and being configured. The term "indication" may be a direct indication, or may be an indirect indication, or may be an association relationship. For example, A indicates B, which may represent that A directly indicates B, for example, B may be obtained by A; or may represent that A indirectly indicates B, for example, A indicates C, and B may be obtained by C; or may represent that there is an association relationship between A and B. The term 'predefined' or 'preconfigured' may refer to codes, tables or other relevant information configured for indication that may be pre-stored in a device, or may refer to conventions agreed upon by a protocol. The "protocol" may refer to a standard protocol in the art. The term "when" may be explained as "if", "as", "in response to", and the like. Similarly, depending on the context, phrases "if determining" or "if detecting (a stated condition or event)" may be explained as "when determining" or "in response to determining" or "when detecting (the stated condition or event)" or "in response to detecting (the stated condition or event)" or the like. The terms "first", "second", "third", "fourth", "A^{th}", "B^{th}", and so on are intended to distinguish different objects rather than to describe a order. The terms "include", "have", and any variant thereof are intended to cover a non-exclusive inclusion. Digital video compression technology mainly involves compressing large amounts of digital video data, so as to facilitate transmission, storage, and the like.

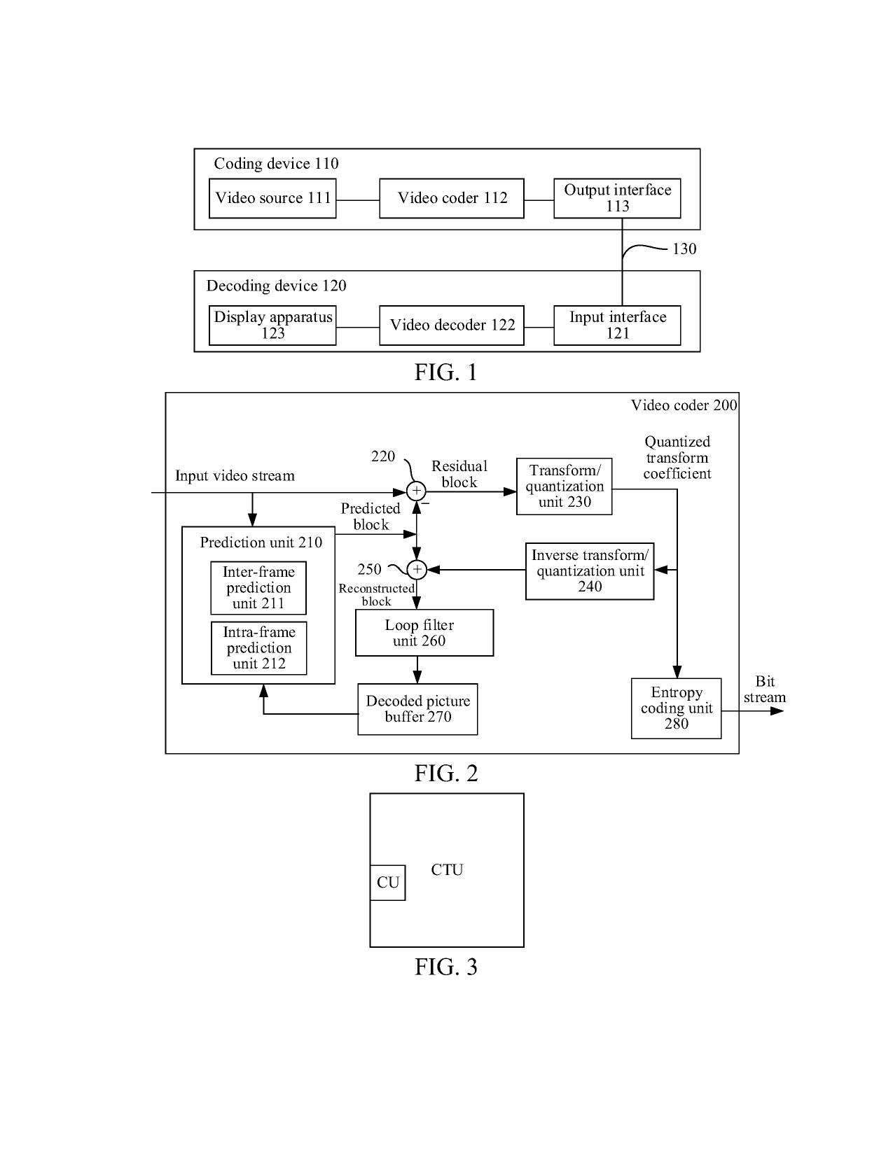

For ease of understanding, the video coding and decoding system in some embodiments is first described with reference to FIG. 1.

FIG. 1 is a schematic block diagram of a video coding and decoding system according to some embodiments.

As shown in FIG. 1, the video coding and decoding system 100 includes a coding device 110 and a decoding device 120.

The coding device 110 is configured to code (for example, compress) video data, so as to generate a bit stream, and transmit the bit stream to the decoding device 120. The decoding device 120 decodes the bit stream generated by the coding device 110 to obtain decoded video data.

The coding device 110 may be understood as a device having a video coding function, and the decoding device 120 may be understood as a device having a video decoding function. That is, in some embodiments, the coding device 110 and the decoding device 120 include a wider range of apparatuses, such as a smartphone, a desktop computer, a mobile computing apparatus, a notebook computer (for example, a laptop), a tablet computer, a set-top box, a television, a camera, a display apparatus, a digital media player, a video game console, and an in-vehicle computer.

The coding device 110 may transmit the coded video data (for example, a bit stream) to the decoding device 120 via a channel 130.

The channel 130 may include one or more media and/or apparatuses capable of transmitting the coded video data from the coding device 110 to the decoding device 120.

The channel 130 may include one or more communication media enabling the coding device 110 to directly transmit the coded video data to the decoding device 120 in real time. The coding device 110 may modulate the coded video data according to a communication standard, and transmit the modulated video data to the decoding device 120. The communication medium includes a wireless communication medium, for example, a radio frequency spectrum. The communication medium may further include a wired communication medium, for example, one or more physical transmission lines.

The channel 130 may include a storage medium, and the storage medium may store video data coded by the coding device 110. The storage medium includes various local access data storage media, for example, an optical disc, a DVD, and a flash memory. In this example, the decoding device 120 may obtain the coded video data from the storage medium.

The channel 130 may include a storage server, and the storage server may store video data coded by the coding device 110. In this example, the decoding device 120 may download the stored coded video data from the storage server. In some embodiments, the storage server may store coded video data and may transmit the coded video data to the decoding device 120, for example, a web server (for example, configured for a website) or a file transfer protocol (FTP) server.

The coding device 110 includes a video coder 112 and an output interface 113.

The output interface 113 may include a modulator/demodulator (modem) and/or a transmitter. The video coder 112 directly transmits coded video data to the decoding device 120 via the output interface 113. The coded video data may further be stored on a storage medium or a storage server for subsequent retrieval by the decoding device 120.

In addition to the video coder 112 and the output interface 113, the coding device 110 may further include a video source 111.

The video source 111 may include at least one of a video capture apparatus (for example, a video camera), a video archive, a video input interface, and a computer graphics system, where the video input interface is configured to receive video data from a video content provider, and the computer graphics system is configured to generate video data. The video coder 112 codes video data from the video source 111, so as to generate a bit stream. The video data may include one or more pictures or a sequence of pictures. The bit stream includes coded information of the pictures or the sequence of pictures in the form of a bit stream. The coded information may include coded picture data and associated data. The associated data may include a sequence parameter set (SPS), a picture parameter set (PPS), and other syntax structures. The SPS may include parameters applied to one or more sequences. The PPS may include parameters applied to one or more pictures. The syntax structure refers to a set of zero or more syntax elements arranged in a specified order in a bit stream.

The decoding device 120 includes an input interface 121 and a video decoder 122. The input interface 121 may include a receiver and/or a modem.

In addition to the input interface 121 and the video decoder 122, the decoding device 120 may further include a display apparatus 123.

The input interface 121 may receive coded video data via a channel 130. The video decoder 122 is configured to decode the coded video data to obtain decoded video data, and transmit the decoded video data to the display apparatus 123. The display apparatus 123 displays the decoded video data. The display apparatus 123 may be integrated with the decoding device 120 or external to the decoding device 120. The display apparatus 123 may include various display apparatuses, for example, a liquid crystal display (LCD), a plasma display, an organic light-emitting diode (OLED) display, or other types of display apparatuses.

FIG. 1 is merely an example of this application, and is not to be understood as a limitation of this application. That is, the technical solutions of some embodiments are not limited to the system framework shown in FIG. 1. For example, the technology of this application may further be applied to one‑sided video coding or one‑sided video decoding.

A video coding framework of some embodiments will be introduced below.

FIG. 2 is a schematic block diagram of a video coder 200 according to some embodiments.

The video coder 200 may be applied to picture data in a Luma-Chroma (YCbCr, YUV) format. For example, the YUV ratio may be 4:2:0, 4:2:2, or 4:4:4, where Y represents Luma, Cb (U) represents blue chroma, Cr (V) represents red chroma, and U and V represent Chroma which is configured for describing colors and saturation. For example, in terms of color format, 4:2:0 represents that for every 4 pixels, there are 4 Luma components and 2 Chroma components (YYYYCbCr), 4:2:2 represents that for every 4 pixels, there are 4 Luma components and 4 Chroma components (YYYYCbCrCbCr), and 4:4:4 represents full-pixel display (YYYYCbCrCbCrCbCrCbCr). Certainly, the video coder may also be applied to picture data in a red-green-blue (RGB) format, which will not be specifically limited in this application.

After the video coder 200 reads a video stream, each frame of picture in the video stream may be partitioned into several coding tree units (CTUs). In some examples, the CTU may be referred to as a tree block, a largest coding unit (LCU), or a coding tree block (CTB). The size of one CTU may be, for example, 128×128, 64×64, or 32×32.

FIG. 3 is a schematic structural diagram showing a relationship between a coding tree unit and a coding unit provided in this application.

As shown in FIG. 3, a CTU may be further partitioned into several coding units (CU) to perform coding. The CU may be a rectangular block, or may be a square block. The CU may be further partitioned into a prediction unit (PU) and a transform unit (TU), thereby separating the coding, prediction, and transform processes for greater flexibility. In an example, the CTU is partitioned into CUs in a tree (for example, quadtree) structure, and the CU is partitioned into a TU and a PU in a tree (for example, quadtree) structure.

The video coder and the video decoder support various PU sizes.

Assuming that the size of a CU is 2N×2N, the video coder and the video decoder support a PU size of 2N×2N or N×N for intra-frame prediction, and support symmetric PUs of 2N×2N, 2N×N, N×2N, N×N, or a similar size for inter-frame prediction. The video coder and the video decoder further support asymmetric PUs of 2N×nU, 2N×nD, nL×2N, and nR×2N for inter-frame prediction.

As shown in FIG. 2, the video coder 200 may include: a prediction unit 210, a residual unit 220, a transform/quantization unit 230, an inverse transform/quantization unit 240, a reconstruction unit 250, a loop filter unit 260, a decoded picture buffer 270, and an entropy coding unit 280. The video coder 200 may include more, fewer, or different functional components. In this application, a current block may be referred to as a current coding unit (CU), a current prediction unit (PU), or the like. A predicted block may also be referred to as a predicted picture block, and a reconstructed picture block may also be referred to as a reconstructed block.

The prediction unit 210 includes an inter-frame prediction unit 211 and an intra-frame prediction unit 212. Due to a strong correlation between neighboring pixels in a picture in a video, in video coding and decoding technology, spatial redundancy between the adjacent pixels is eliminated using an intra-frame prediction method. Due to the strong similarity between neighboring pictures in a video, temporal redundancy between the neighboring pictures is eliminated using an inter-frame prediction method, thereby improving the coding efficiency.

The inter-frame prediction unit 211 may be configured for inter-frame prediction, which may include motion estimation and motion compensation. With reference to picture information of different frames, inter-frame prediction uses motion information to find a reference block from a reference frame, and then a predicted block is generated according to the reference block, thereby eliminating temporal redundancy. The reference frame may be a P-frame and/or a B-frame, where the P-frame refers to a forward predicted frame, and the B-frame is a bidirectional predicted frame. In inter-frame prediction, a reference block is found using motion information, and then a predicted block is generated according to the reference block. The motion information includes a frame list to which the reference frame belongs, a frame index, and a motion vector. The motion vector may be an integer pixel or a sub-pixel. If the motion vector is a sub-pixel, then a required sub-pixel block may be made in a reference frame using an interpolation filter. The reference block is an integer pixel or sub-pixel block found according to the motion vector. In some technology, a reference block is directly used as a predicted block, while in some technology, a reference block is processed to generate a predicted block. Further processing a reference block to generate a predicted block may also be understood as using a reference block as a predicted block and then processing the predicted block to generate a new predicted block.

The intra-frame prediction unit 212 predicts pixel information within a current code picture block with reference to only information about the same frame of picture, thereby eliminating spatial redundancy. A reference frame configured for intra-frame prediction may be an I-frame.

There are multiple prediction modes for intra-frame prediction. Prediction may be performed on a to-be-coded picture block by an angle prediction mode and a non-angle prediction mode to obtain a predicted block. An optimal prediction mode for the to-be-coded picture block is selected according to rate distortion information computed from the predicted block and the to-be-coded picture block, and the prediction mode is written to a bit stream and transmitted to a decoder side. The decoder side parses the prediction mode, then performs prediction to obtain a predicted block of a target decoding block, and adds a temporal residual block acquired based on the bit stream to the predicted block, thereby obtaining a reconstructed block.

Using the H series of international digital video coding standards as an example, the H.264/AVC standard has 8 angle prediction modes and one non-angle prediction mode, and H.265/HEVC extends to 33 angle prediction modes and two non-angle prediction modes. An intra-frame prediction mode used in HEVC includes a planar mode, a direct current (DC) mode, and 33 angle modes, totaling 35 prediction modes. Intra-frame modes used in VVC include a planar mode, a DC mode, and 65 angle modes, totaling 67 prediction modes, which include a prediction mode and a non-prediction mode. The non-prediction mode may include a matrix weighted intra-frame prediction (MIP) mode. The prediction modes include: a planar mode with a mode number of 0, a DC mode with a mode number of 1, and angle prediction modes with a mode number of 2 to a mode number of 66. With the increase of the angle modes, a prediction result of intra-frame prediction will be more accurate, and better meets the requirements for the development of high-definition and ultra-high-definition digital videos. The above intra-frame prediction mode is merely an example of this application, and is not to be construed as limiting this application.

The residual unit 220 may generate, based on a pixel block of a CU and a predicted block of a PU of the CU, a residual block of the CU. For example, the residual unit 220 may generate a residual block for the CU such that each sample in the residual block equals a difference between a sample in the pixel block of the CU and the corresponding sample in the predicted block of the PU of the CU.

The transform/quantization unit 230 may quantize a transform coefficient. The transform/quantization unit 230 may quantize, based on a quantization parameter (QP) value associated with the CU, a transform coefficient associated with a TU of the CU. The video coder 200 may adjust, by adjusting the QP value associated with the CU, the degree of quantization applied to the transform coefficient associated with the CU.

The inverse transform/quantization unit 240 may apply inverse quantization and inverse transform to the quantized transform coefficient, so as to reconstruct a residual block from the quantized transform coefficient.

The reconstruction unit 250 may add samples of the reconstructed residual block to corresponding samples of one or more predicted blocks generated by the prediction unit 210, so as to generate a reconstructed picture block associated with the TU. By reconstructing a sample block of each TU of the CU in this way, the video coder 200 may reconstruct a pixel block of the CU.

The loop filter unit 260 is configured to process pixels obtained after inverse transform and inverse quantization to reduce distortion, thereby providing a better reference for subsequent coding of the pixels. For example, a deblocking filter operation may be executed, so as to reduce block artifacts of pixel blocks associated with the CU. In some embodiments, the loop filter unit 260 includes: a deblocking filter (DBF) unit and a sample adaptive offset/adaptive loop filter (SAO/ALF) unit, where the DBF unit is configured to remove block artifacts, and the SAO/ALF unit is configured to remove ringing artifacts.

The decoded picture buffer 270 may store reconstructed pixel blocks.

The inter-frame prediction unit 211 may execute inter-frame prediction on PUs of other pictures using a reference picture that includes the reconstructed pixel block in the decoded picture buffer 270. In addition, the intra-frame prediction unit 212 may execute intra-frame prediction on other PUs in the same picture as a CU using the reconstructed pixel block in the decoded picture buffer 270.

The entropy coding unit 280 may receive a quantized transform coefficient from the transform/quantization unit 230. The entropy coding unit 280 may execute one or more entropy coding operations on the quantized transform coefficient, so as to generate entropy coded data.

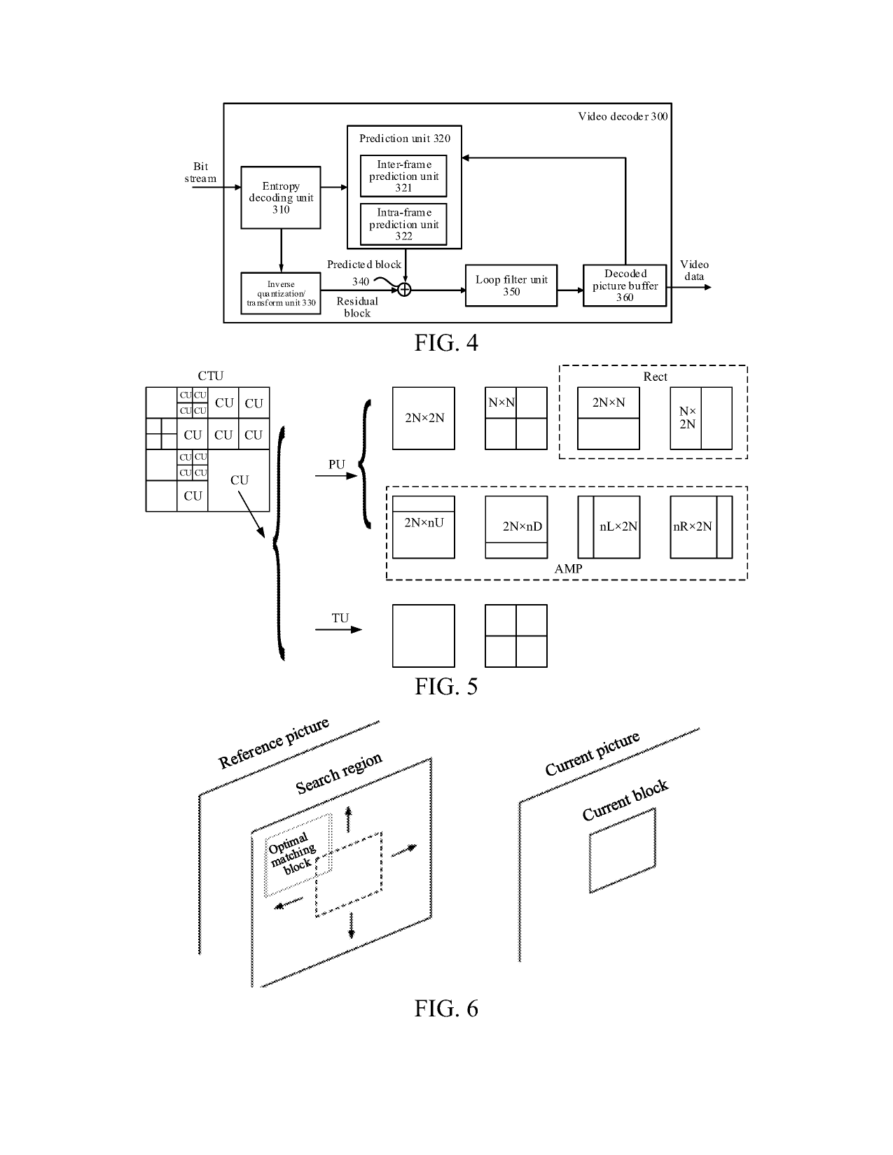

FIG. 4 is a schematic block diagram of a video decoder according to some embodiments.

As shown in FIG. 4, the video decoder 300 includes: an entropy decoding unit 310, a prediction unit 320, an inverse quantization/transform unit 330, a reconstruction unit 340, a loop filter unit 350, and a decoded picture buffer 360. The video decoder 300 may include more, fewer, or different functional components.

The video decoder 300 may receive a bit stream. The entropy decoding unit 310 may parse the bit stream to extract a syntax element from the bit stream. As a part of parsing the bit stream, the entropy decoding unit 310 may parse an entropy coded syntax element in the bit stream. The prediction unit 320, the inverse quantization/transform unit 330, the reconstruction unit 340, and the loop filter unit 350 may decode video data according to a syntax element extracted from the bit stream, for example, generate decoded video data.

The prediction unit 320 includes an intra-frame prediction unit 322 and an inter-frame prediction unit 321.

The intra-frame prediction unit 322 may execute intra-frame prediction, so as to generate a predicted block of the PU. The intra-frame prediction unit 322 may use an intra-frame prediction mode to generate, based on pixel blocks of spatially neighboring PUs, the predicted block of the PU. The intra-frame prediction unit 322 may further determine an intra-frame prediction mode of the PU according to one or more syntax elements parsed from the bit stream.

The inter-frame prediction unit 321 may construct a first reference picture list (list 0) and a second reference picture list (list 1) according to the syntax element(s) parsed from the bit stream. In addition, if the PU uses inter-frame prediction coding, the entropy decoding unit 310 may parse motion information of the PU. The inter-frame prediction unit 321 may determine one or more reference blocks of the PU according to the motion information of the PU. The inter-frame prediction unit 321 may generate a predicted block of the PU according to the one or more reference blocks of the PU.

The inverse quantization/transform unit 330 may perform inverse quantization (for example, dequantization) on a transform coefficient associated with the TU. The inverse quantization/transform unit 330 may determine the degree of quantization using a QP value associated with a CU of the TU. After the inverse quantization of the transform coefficient, the inverse quantization/transform unit 330 may apply one or more inverse transforms to the inverse quantized transform coefficient, so as to generate a residual block associated with the TU.

The reconstruction unit 340 reconstructs a pixel block of the CU using the residual block associated with the TU of the CU and the predicted block of the PU of the CU. For example, the reconstruction unit 340 may add samples of the residual block to corresponding samples of the predicted block to reconstruct the pixel block of the CU, so as to obtain a reconstructed picture block.

The loop filter unit 350 may perform a deblocking filter operation, so as to reduce block artifacts of pixel blocks associated with the CU.

The video decoder 300 may store a reconstructed picture of the CU in the decoded picture buffer 360. The video decoder 300 may use the reconstructed picture in the decoded picture buffer 360 as a reference picture for subsequent prediction, or, transmit the reconstructed picture to a display apparatus for display.

With reference to FIG. 2 and FIG. 4, the process of video coding and decoding is as follows:

On a coder side, a frame of picture is partitioned into picture blocks. For a current block, the prediction unit 210 predicts a predicted block of the current block (for example, a to-be-coded block) using intra-frame prediction or inter-frame prediction. The residual unit 220 may compute a residual block based on the predicted block and an original block of the current block (for example, the to-be-coded block), where the residual block is a difference value between the predicted block and the original block. The residual block may also be referred to as residual information. The residual block is transformed and quantized via the transform/quantization unit 230, so that information insensitive to the human eyes may be removed, thereby eliminating visual redundancy. In some embodiments, the residual block before being transformed and quantized via the transform/quantization unit 230 may be referred to as a temporal residual block, and the residual block after being transformed and quantized via the transform/quantization unit 230 may be referred to as a frequency residual block or a frequency-domain residual block. The entropy coding unit 280 receives a quantized transform coefficient outputted by the transform/quantization unit 230, and may perform entropy coding on the quantized transform coefficient, so as to output a bit stream. For example, the entropy coding unit 280 may eliminate statistical redundancy according to a target context model and the probability information of a binary bit stream.

On a decoder side, the entropy decoding unit 310 may parse a bit stream to obtain prediction information, a quantization coefficient matrix, and the like of a current block (for example, a to-be-decoded block). The prediction unit 320 predicts, based on the prediction information, a predicted block of the current block (for example, the to-be-decoded block) using intra-frame prediction or inter-frame prediction. The inverse quantization/transform unit 330 performs inverse quantization and inverse transform on the quantization coefficient matrix obtained from the bit stream to obtain a residual block. The reconstruction unit 340 adds the predicted block and the residual block to obtain a reconstructed block. The reconstructed blocks form a reconstructed picture, and the loop filter unit 350 performs, based on the picture or based on the blocks, loop filtering on the reconstructed picture to obtain a decoded picture. The coder side also may use an operation similar to that of the decoder to obtain a decoded picture. The decoded picture may also be referred to as a reconstructed picture, which may serve as a reference picture for inter-frame prediction of subsequent pictures.

In addition, block partitioning information determined by the coder, mode information or parameter information such as prediction, transform, quantization, entropy coding, and loop filtering, and the like are carried in the bit stream when necessary. By parsing a bit stream and performing analysis according to the existing information, the decoder side determines block partitioning information, mode information or parameter information such as prediction, transform, quantization, entropy coding, and loop filtering, and the like that are the same as those of the coder side, thereby guaranteeing that the decoded picture obtained by the coder is the same as the decoded picture obtained by the decoder.

To facilitate parallel processing, a picture may be partitioned into slices and the like, and slices in the same picture may be processed in parallel, for example, there is no data dependency between the slices. The term "frame" may be understood as a picture, a slice, or the like. The foregoing is the process of a video codec under a block-based codec framework. With the development of technology, some modules or operations of the framework or the process may be optimized. That is, this application is not limited to the framework and the process.

For ease of understanding the technical solutions provided in this application, the related content will be described below.

### 1 Coding Unit Partitioning

A frame of picture is sent to a coder and first partitioned into coding tree units (CTUs) according to a block size of 64×64, and the CTUs are then recursively partitioned to obtain coding units (CUs). Each CU includes a prediction unit (PU) and a transform unit (TU). Prediction is performed on each PU to obtain a predicted value. The predicted value is subtracted from input data to obtain a residual. The residual then undergoes discrete cosine transform (DCT) transform and quantization to obtain a residual coefficient. The residual coefficient is then sent to an entropy coding module to output a bit stream. Meanwhile, the residual coefficient undergoes inverse quantization and inverse transform to obtain a residual value of a reconstructed picture, and then the residual value is added to the predicted value to obtain a reconstructed picture. After undergoing in-loop filtering, the reconstructed picture enters a reference picture queue, and is used as a reference picture for a next frame, thereby implementing sequential coding.

During actual prediction, starting from a largest coding unit (LCU), each layer is partitioned downward layer by layer using a quadtree structure for recursive calculation. First, top-down partitioning is performed. Starting from depth=0, a 64×64 block is first partitioned into four 32×32 sub-CUs. Then, one of the 32×32 sub-CUs is further partitioned into four 16×16 sub-CUs, and so on, until depth = 3, and the size of the CU is 8×8. Then, bottom-up pruning is performed. Rate distortion costs (RDcosts) (denoted as cost1) of four 8×8 CUs are summed to obtain RDcost of a current level, and the sum is compared with the RDcost (denoted as cost2) corresponding to a previous level (i.e., 16×16 CU). If cost1 is less than cost2, partitioning of the 8×8 CUs is retained. Otherwise, upward pruning is continued, and layer-by-layer comparison is performed. Finally, an optimal CU depth partitioning is found.

PU prediction is divided into an intra-frame mode and an inter-frame mode. First, different PUs are compared in the same prediction mode to find an optimal partition mode. Then, the intra-frame mode and the inter-frame mode are compared to find an optimal prediction mode for a current CU. Meanwhile, residual quad-tree transform (RQT) is performed on a CU to find an optimal TU mode. Finally, a frame of picture is partitioned into CUs, each with corresponding PUs and TUs.

FIG. 5 is a schematic diagram of partition modes of PUs and TUs according to some embodiments.

As shown in FIG. 5, the PU has eight partition modes in total. For example, assuming that the size of a current CU is 2N×2N, the partition modes of the PU include the following eight partition modes: no partitioning, partition into N×N, partition into 2N×N, partition into N×2N, partition into 2N×nU, partition into 2N×nD, partition into nL×N, and partition into nR×N. The TU only has two partition modes: partitioning or no partitioning.

The above describes a framework of a coding kernel. The most computationally complex processes include coding unit partition decision and CU/PU/TU partition decision. There are also relatively large computing resource processing flows such as motion estimation (ME) and motion compensation (MC).

### 2 Motion Estimation.

Motion estimation may be classified into a full-pixel motion prediction mode and a sub-pixel motion prediction mode. Different search modes or algorithms may be used in the motion estimation. The search modes include, but are not limited to, diamond (DIA), hexagon (hex), uneven multi-hex (umh), exhaustive (esa), and transformed exhaustive (tesa). merange is a parameter for controlling a maximum motion search range in units of pixels. subme is a parameter used for representing sub-pixel estimation complexity (0 to 10). The larger the value of the parameter, the higher the search complexity.

FIG. 6 is a schematic diagram showing the principle of motion estimation according to some embodiments.

As shown in FIG. 6, the motion estimation searches for a suitable matching region B (for example, an optimal matching block) in a reference picture for a region A (for example, a current block) of a current picture. The reference picture may be a previous picture, or may be a subsequent picture.

### 3 Motion Compensation

Motion compensation is performed based on a motion estimation result. Using a motion vector obtained by estimation, motion compensation may predict and compensate for the next picture in a picture sequence, thereby reducing the redundancy of video data. In short, a previous local picture is used in the motion compensation to predict and compensate for a current local picture, thereby reducing redundant information in the picture sequence.

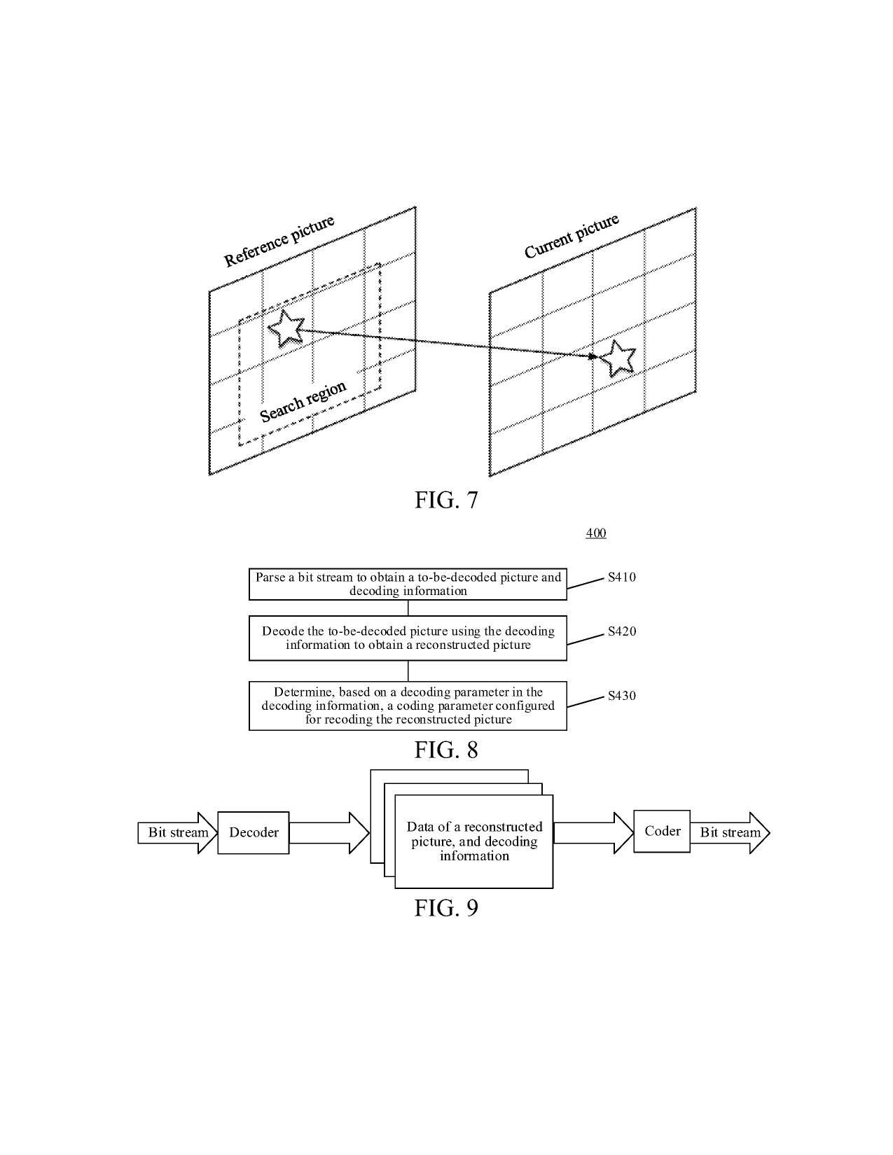

FIG. 7 is a schematic diagram showing the principle of motion compensation according to some embodiments.

As shown in FIG. 7, based on a motion estimation result, the motion compensation may be used for finding (or determining) a difference (or discrepancy) between region A and region B.

Some motion vectors and residuals may be obtained by the motion estimation and the motion compensation. The motion vectors are motion trajectories of some regions for a reference picture, and the residuals are differences or discrepancies between a predicted picture generated from these motion-compensated regions and a current picture.

Residual computation (e.g., SAD or sum of squared differences (SSD)) is also computationally complex. This is basically performed together with coding unit partitioning, MC, and ME. Computing resources consumed by the residual computation may be controlled by controlling the algorithm complexity of coding unit partitioning, ME, and MC, as well as a search region (for example, merange).

### 4 Transform Operation.

Transform operation is the most complex of atomic operations in a video coder.

The size of a TU of an H.265 coder may range from 32×32 to 4×4 across four depths in total. Since there are a large number of matrix multiplication operations in a process, the complexity is very high even if assembly acceleration is used. Therefore, the computation complexity of the transform operation may be controlled by controlling parameters. For example, the computation complexity of the transform operation may be controlled in the following ways:

1. Transform and quantization are skipped when prediction distortion is relatively small (for example, very small).

2. If the rate distortion and a residual coding result of a current transform block are relatively small (for example, very small), then the benefit of performing deeper TU partitioning is very small, for example, the TU partitioning depth may be controlled.

3. A transform module and a quantization module are usually operated together. If the distribution of transform coefficients is sparse, quantization may be skipped and directly forced to 0.

4. A maximum TU depth of a current CU may be adaptively determined according to information of neighboring TUs.

The technical problem to be resolved in this application will be described below.

In recent years, the video industry has developed rapidly, and video applications are rapidly upgrading towards high definition and high frames per second (FPS). With the rapid development of video services such as short videos, e-commerce live streaming, and real-time "cloud" rendering, the demand for video processing is growing. As the foundation of video processing, video coding with excellent coding capability may provide high-definition and smooth playback experience for a product, and plays an important role in improving the quality of experience (QoE)/quality of service (QoS).

Scenarios such as live streaming, real-time communication (RTC), cloud rendering, and cloud desktop all have relatively high requirements on the frame output stability of a video coding kernel.

Usually, computing resources consumed by the video coding kernel are related to the complexity of a video image.

For example, static images or images with low motion texture are relatively easy to compress, and consume relatively few computing resources. However, the compression of images with a relatively complex motion texture consumes relatively more computing resources. If an image texture of a compressed video is relatively complex, and scene switching is relatively frequent, computing resources consumed in video coding compression may fluctuate significantly.

However, when the computing resource fluctuates significantly, the central processing unit (CPU) consumption of a server may fluctuate significantly. When the CPU consumption fluctuates significantly, the frame output stability may be affected, and especially for scenarios such as live streaming, RTC, cloud rendering, and cloud desktop, the deployment costs of the server may also increase. The reason is that a relatively large number of computing resources need to be reserved as buffer space for computing resource orchestration and scheduling, so as to handle fluctuations of the computing resources during the scene switching of a video image. For example, when a server runs 10 live video coding streams simultaneously, the CPU utilization may be controlled to be 50% or below to the greatest extent during scheduling. This prevents server computing resource overload caused by simultaneous surges in computing resource consumption when all 10 video coding streams switch to complex texture scenes, thereby ensuring the frame output stability in video coding.

In view of this, some embodiments provide a coding parameter determining method and apparatus, an electronic device, and a storage medium, which can improve the frame output stability of a coding kernel and reduce the deployment costs of a server. The coding parameter determining method provided in this application may also be referred to as a picture coding method, a coding method, a picture recoding method, and the like, which will not be specifically limited in this application.

The coding parameter determining method provided in this application will be described below.

FIG. 8 is a schematic flowchart of a coding parameter determining method 400 according to some embodiments.

The method 400 may be executed by any device having a data processing capability. For example, the method 400 may be executed by the coding device 110 shown in FIG. 1. For another example, the method 400 may be executed by the video coder 200 shown in FIG. 2. For ease of description, it is illustrated below with the coding parameter determining apparatus taken as an example.

As shown in FIG. 8, the method 400 may include some or all of the following:

S410: A coding parameter determining apparatus parses a bit stream to obtain a to-be-decoded picture and decoding information.

Exemplarily, the coding parameter determining apparatus parses a video or picture bit stream to extract a to-be-decoded picture and related decoding information. The decoding information may include some parameters used for picture decoding.

In some embodiments, the decoding information includes at least one of the following: picture type, partition type, macroblock type, motion vector, macroblock size, bit rate, quantization parameter, and the number of bits occupied by a macroblock in a bit stream.

Exemplarily, the picture type is also referred to as a frame type, and the frame type refers to a type of a frame, such as an I-frame, a P-frame, and a B-frame. The I-frame is a key frame, which does not refer to any other frames. P-frame: A forward predictive coded frame. The P-frame represents a difference between a current frame and a previous key frame (or a P-frame), and a difference defined in the current frame may be added to a previously cached image during decoding to generate a final image. B-frame: A bidirectional predictive interpolated coded frame. The B-frame is a bidirectional difference frame. In other words, the B-frame records a difference between a current frame and previous and subsequent frames. The B-frame may be used as a reference frame for other B-frames, or may not be used as the reference frame for other B-frames.

Exemplarily, the partition type may also be referred to as a partition manner, a partitioning mode, a partitioning manner, or the like, which may be a partition type of a macroblock. Certainly, in other alternative embodiments, partition types of CUs, PUs, or TUs. For example, the partition type may include, but is not limited to, 128×128, 64×64, 32×32, 16×16, 16×8, 8×16, 8×8, 4×4, and the like.

Exemplarily, the type of the macroblock may be an intra-frame macroblock, an inter-frame macroblock, or a skip macroblock. During video coding, a macroblock is a coding unit. Certainly, in other alternative embodiments, the type of the macroblock may also be replaced with a CU, PU, or TU type.

Exemplarily, the motion vector is a vector used for representing the motion of a pixel between adjacent frames, and may be used for predicting and coding the movement trajectory of a moving object.

Exemplarily, the macroblock size is a size of a macroblock obtained after the macroblock is partitioned. For example, the macroblock size may include, but is not limited to: 128×128, 64×64, 32×32, 16×16, 16×8, 8×16, 8×8, 4×4, and the like. Certainly, in other alternative embodiments, the macroblock size may also be replaced with a CU, PU, or TU size.

Exemplarily, the bit rate refers to a data volume that may be transmitted in a given time. In video coding, the bit rate is usually configured for measuring the compression efficiency. A relatively low bit rate means a relatively small amount of transmitted data, but may result in loss of some picture quality.

Exemplarily, the quantization parameter is an important parameter configured for controlling the loss of picture quality. A relatively low quantization parameter means relatively good picture quality but a relatively large amount of transmitted data. A relatively high quantization parameter means relatively large loss of picture quality but a relatively small amount of data.

Exemplarily, the number of bits occupied by a macroblock in a bit stream is the number of bits occupied by a macroblock in a compressed video bit stream, depending on various factors, such as a macroblock type, a partition type, and a motion vector.

Certainly, in other alternative embodiments, the decoding information may also include other information. For example, the decoding information may include a frame size, which usually refers to the size of a frame of picture, for example, a size of 1920×1080. For another example, the decoding information may include a reference frame, which is used for decoding and predicting reference frames of other frames. During video coding, to reduce a data volume, a coder usually codes a current frame with reference to a previous frame (for example, the reference frame).

S420: The coding parameter determining apparatus decodes the to-be-decoded picture using the decoding information to obtain a reconstructed picture.

Exemplarily, the coding parameter determining apparatus decodes the to-be-decoded picture using the decoding information to obtain the reconstructed picture. For example, the coding parameter determining apparatus may obtain a predicted picture and a residual picture using the decoding information, and then sum the two pictures to obtain the reconstructed picture, or may perform processing such as inverse quantization and inverse transform on a picture obtained by summing the two pictures to obtain the reconstructed picture.

Exemplarily, the coding parameter determining apparatus decodes the to-be-decoded picture using the decoding information to obtain the reconstructed picture, and then may store the decoding information. For example, the coding parameter determining apparatus may store the decoding information along with the reconstructed picture. For example, the coding parameter determining apparatus may store the decoding information along with data (for example, YUV information) of the reconstructed picture.

S430: The coding parameter determining apparatus determines a coding parameter configured for recoding the reconstructed picture based on the decoding parameter in the decoding information.

Exemplarily, when recoding reconstructed picture blocks in the reconstructed picture, the coding parameter determining apparatus may determine, using a policy or by considering some influence factors, whether to use the decoding parameter in the decoding information, and determine, in a case of determining to use the decoding parameter and based on the decoding parameter in the decoding information, the coding parameter configured for recoding the reconstructed picture. For example, when recoding the reconstructed picture blocks in the reconstructed picture, the coding parameter determining apparatus may determine, based on factors such as the picture quality of the reconstructed picture, a spatial computing resource of a coder, and a service scenario, whether to use the decoding parameter in the decoding information.

Exemplarily, if determining to use the decoding parameter in the decoding information to determine the coding parameters of the reconstructed picture, the coding parameter determining apparatus may determine parameters in the decoding information that match the coding parameters as the coding parameters. The decoding parameter may be information configured for providing reference for the coding parameter determining apparatus to determine the coding parameter. In other words, the decoding parameter is configured for providing reference for the coding parameter determining apparatus to determine the coding parameter.

Exemplarily, the coding parameter determining apparatus directly reuses the decoding parameter as the coding parameter, or may process the decoding parameter to obtain the coding parameter, or may simplify, based on the decoding parameter, a default computation mode of the coding parameter to obtain the coding parameter, which will not be specifically limited in this application.

In this embodiment, the coding parameter determining apparatus first parses a bit stream to obtain a to-be-decoded picture and decoding information; then decodes the to-be-decoded picture using the decoding information to obtain a reconstructed picture; and determines, based on a decoding parameter in the decoding information, a coding parameter configured for recoding the reconstructed picture. In other words, when determining the coding parameter of the reconstructed picture, the coding parameter determining apparatus may determine the coding parameters by considering reusing the decoding parameter in the decoding information, so as to reduce the computation complexity of the coding parameters, thereby improving the frame output stability of a coding kernel and reducing the deployment costs of a server.

Usually, when a coder is applied, some processing algorithms and configurations related to coding (such as coding complexity, bit rate, the number of reference frames for lookahead, the size of a key group of pictures (KEY GOP), whether to enable B-frames, a coding rate control manner (for example, a manner for controlling the size of a bit stream outputted by the coder), an algorithm for motion estimation, an algorithm for motion compensation, and whether to enable a related algorithm in lookahead) are set. After these parameters of the coding kernel are set, when video sources are subsequently input and coded, any processing algorithms and configurations related to coding will not change adaptively. This means that a process (e.g., coding unit partitioning, motion estimation, motion compensation, transform, or preprocessing) configured for determining a coding parameter that consumes relatively high computing resources will also be a fixed process. In this embodiment, the coding parameters are determined using the decoding parameter in the decoding information, thereby avoiding that the coding parameters are determined using an algorithm and a configuration that consume relatively high computing resources. Therefore, the computation complexity of the coding parameters can be reduced, thereby improving the frame output stability of a coding kernel and reducing the deployment costs of a server.

In other alternative embodiments, for the reconstructed picture, the process (e.g., coding unit partitioning, motion estimation, motion compensation, transform, or preprocessing) configured for determining a coding parameter that consumes relatively high computing resources may also be adaptively tailored based on an analysis result (e.g., an analysis result of the texture complexity of an image scene or an analysis result of image scene) or a detection result (such as a detection result of image scene switching detection or a detection result of image texture detection) in the lookahead process, thereby reducing computing resources consumed in video coding compression in a case of a loss in BD-rate.

However, a significant disadvantage of such solutions lies in the fact that decoding information of a reconstructed picture is not reused. On one hand, since the lookahead is analysis performed using a coded picture, an analysis result or a detection result of the lookahead is not timely enough, and there may be a delay of several groups of pictures (GOPs). This means that even if a process configured for determining a coding parameter is adaptively tailored based on the analysis result or the detection result in the lookahead process, since the analysis result or the detection result is not timely enough, the reference value of the analysis result or the detection result may be reduced, thereby reducing the accuracy of the coding parameters and the coding performance of a coder. On the other hand, if the process for determining the coding parameter is adaptively tailored excessively, the image quality of a video image may be greatly affected, and the image stability is reduced, thereby reducing the coding performance. In this embodiment, the coding parameter is determined by reusing the decoding parameter in the decoding information, so as to reduce computation complexity of the coding parameters, thereby improving the frame output stability of a coding kernel and the coding performance of the coder. In addition, since the decoding information is real-time information configured for decoding the reconstructed picture, when determining, based on a decoding parameter in the decoding information, a coding parameter configured for recoding the reconstructed picture, the accuracy of the coding parameters can be guaranteed, thereby improving the coding performance of the coder.

The to-be-decoded picture of this application may be understood as or replaced with a coding result of a picture obtained after coding, a coded picture, a residual picture, and the like. The reconstructed picture of this application may be understood as or replaced with a picture obtained after decoding, a decoded picture, a picture obtained after a predicted picture and a residual picture are summed, and the like, which will not be specifically limited in this application.

FIG. 9 is another schematic flowchart of a coding parameter determining method according to some embodiments.

As shown in FIG. 9, the coding parameter determining apparatus not only may have a decoding function, but also may have a coding function. Specifically, after receiving a bit stream, the parameter determining apparatus decodes the bit stream, and in the decoding process, decoding information such as picture type, partition type, macroblock type, motion vector, macroblock size, bit rate, quantization parameter, and the number of bits occupied by a macroblock in the bit stream may be obtained. Based on the above, when recoding reconstructed picture blocks in the reconstructed picture, the coding parameter determining apparatus determines whether to use the decoding information to determine the coding parameters of the reconstructed picture; determines, if determining to use the decoding information to determine the coding parameters of the reconstructed picture, parameters in the decoding information that match the coding parameters; and determines, based on the matched parameters, the coding parameters. That is, the solution provided in this application is applicable to determining videos that have undergone coding and decoding, for example, those compressed and decompressed using a video compression algorithm such as H.264/VP8/VP9/H.265/H.266/AV1/AVS3, rather than originally captured videos such as YUV, RGB, or NV12.

In some embodiments, before S430, the method 400 may further include:

determining, by the coding parameter determining apparatus, as the decoding parameter, a parameter in the decoding information that has the same parameter type as the coding parameter.

Exemplarily, when determining the decoding parameter, the coding parameter determining apparatus searches for a parameter in the decoding information that has the same parameter type as the coding parameter as the decoding parameter. For example, if the coding parameter is a quantization parameter (QP), the decoding parameter is a QP in the decoding information. If the coding parameter is a motion vector (MV), then the decoding parameter is an MV in the decoding information.

In this embodiment, the coding parameter determining apparatus uses the parameters of the same type as the decoding parameter, thereby guaranteeing the reference effect of the decoding parameter, and further improving the coding effect of the coding parameter.

Certainly, in other alternative embodiments, the coding parameter determining apparatus may also determine, as the decoding parameter, a parameter in the decoding information that has the same parameter type as a parameter used in the computation process of the coding parameter, which will not be specifically limited in this application.

In some embodiments, S430 may include:

determining, by the coding parameter determining apparatus, the decoding parameter as the coding parameter.

Exemplarily, when determining the decoding parameter, the coding parameter determining apparatus searches for a parameter in the decoding information that has the same parameter type as the coding parameter as the decoding parameter. For example, if the coding parameter determining apparatus may determine a QP, then the coding parameter determining apparatus may directly determine the QP in the decoding information. For another example, if the coding parameter determining apparatus may determine an MV, then the coding parameter determining apparatus may directly determine the MV in the decoding information.

In this embodiment, the coding parameter determining apparatus determines the decoding parameter as the coding parameter, thereby simplifying the computation complexity when determining the coding parameter to the greatest extent.

In some embodiments, S430 may include:

determining, by the coding parameter determining apparatus, based on the decoding parameter, the coding parameter using a parameter computation mode matching a parameter type of the coding parameter.

Exemplarily, the coding parameter determining apparatus may adjust or fine-tune the decoding parameter using a parameter computation mode matching a parameter type of the coding parameter to obtain the coding parameter.

Exemplarily, the coding parameter includes at least one parameter. For a first parameter in the at least one parameter, the coding parameter determining apparatus may compute, based on a parameter in the decoding parameter that has the same parameter type as the first parameter, the first parameter using the parameter computation mode matching the parameter type of the first parameter.

In this embodiment, the coding parameter determining apparatus computes, based on a parameter in the decoding parameter that has the same parameter type as the first parameter, the first parameter using the parameter computation mode matching the parameter type of the first parameter. In other words, the coding parameter determining apparatus may select an appropriate computation mode according to the parameter type of the coding parameter to compute the coding parameter, thereby reducing the computation complexity of the coding parameter, improving the coding efficiency, enhancing the accuracy of the coding parameter, and further improving the coding effect.

In some embodiments, if the coding parameter includes a first motion vector, the parameter computation mode matching the parameter type of the coding parameter includes a parameter computation mode matching a motion vector, and the parameter computation mode matching the motion vector includes at least one of the following:

a first search mode in which search is performed with a motion vector in the decoding parameter taken as a starting search point;

a second search mode in which search is performed with higher precision than a precision of the motion vector in the decoding parameter; and

a third search mode in which a search range is smaller than a search range used in a default computation mode of the motion vector.

Exemplarily, if the decoding parameter includes a second motion vector, the coding parameter determining apparatus may determine, based on the second motion vector, the first motion vector using the parameter computation mode matching the motion vector.

For example, the coding parameter determining apparatus may determine, based on the second motion vector, the first motion vector using the first search mode. That is, the coding parameter determining apparatus may search for the first motion vector using the second motion vector as a starting search point. For another example, the coding parameter determining apparatus may determine, based on the second motion vector, the first motion vector using the second search mode. That is, the coding parameter determining apparatus may determine, as the first motion vector, a motion vector having higher precision than the second motion vector. For another example, the coding parameter determining apparatus may determine, based on the second motion vector, the first motion vector using the third search mode. That is, the coding parameter determining apparatus may determine the first motion vector using a first search range. The first search range may be smaller than a search range used in a default computation mode of the motion vector.

In this embodiment, the parameter computation mode matching the motion vector includes at least one of the following: a first search mode in which search is performed with a motion vector in the decoding parameter taken as a starting search point; a second search mode in which search is performed with higher precision than a precision of the motion vector in the decoding parameter; and a third search mode in which a search range is smaller than a search range used in a default computation mode of the motion vector, thereby reducing the computation complexity of the coding parameter, improving the coding efficiency, enhancing the accuracy of the first motion vector, and further improving the coding effect.

Certainly, when the coding parameter includes other parameters other than a motion vector, the parameter computation mode matching the parameter type of the coding parameter may also include the parameter computation mode matching the parameter types of the other parameters, which will not be specifically limited in this application.

In some embodiments, S430 may include:

determining, by the coding parameter determining apparatus, based on the decoding parameter, a candidate parameter set for the coding parameter; and traversing parameters in the candidate parameter set, and determining an optimal parameter in the candidate parameter set as the coding parameter.

In this embodiment, the coding parameter determining apparatus determines, based on the decoding parameter, a candidate parameter set for the coding parameter; and parameters in the candidate parameter set are traversed, and an optimal parameter in the candidate parameter set is determined as the coding parameter, thereby reducing the computation complexity of the coding parameter and improving the coding efficiency, and also guaranteeing the accuracy of the coding parameter and the coding effect thereof.

In some embodiments, if the coding parameter includes a first partition type, the candidate parameter set for the first partition type includes: a partition type in the decoding parameter, a partition type of a higher level of a level to which the partition type in the decoding parameter belongs, and a partition type of a lower level of the level to which the partition type in the decoding parameter belongs.

Exemplarily, the first partition type refers to the size of a picture block obtained by partitioning a reconstructed picture in the recoding process of the reconstructed picture. The partition type in the decoding parameter refers to the size of a picture block obtained by partitioning a to-be-decoded picture in the decoding process of the to-be-decoded picture.

Exemplarily, the level to which the partition type in the decoding parameter belongs refers to a granularity level of a picture block obtained by partitioning a to-be-decoded picture in the decoding process of the to-be-decoded picture. For example, the height or the width of the picture block may be determined as the granularity level. The higher level refers to a granularity level of a picture block obtained by partitioning a to-be-decoded picture according to the number of times of partitioning being the number of times of partitioning corresponding to the partition type in the decoding parameter minus 1 in the decoding process of the to-be-decoded picture. The partition type of the higher level refers to the size of a picture block obtained by partitioning a to-be-decoded picture according to the number of times of partitioning being the number of times of partitioning corresponding to the partition type in the decoding parameter minus 1 in the decoding process of the to-be-decoded picture. The lower level refers to a granularity level of a picture block obtained by partitioning a to-be-decoded picture according to the number of times of partitioning being the number of times of partitioning corresponding to the partition type in the decoding parameter plus 1 in the decoding process of the to-be-decoded picture. The partition type of the lower level refers to the size of a picture block obtained by partitioning a to-be-decoded picture according to the number of times of partitioning being the number of times of partitioning corresponding to the partition type in the decoding parameter plus 1 in the decoding process of the to-be-decoded picture.

Exemplarily, if the coding parameter includes a first partition type and the decoding parameter includes a second partition type matching the first partition type, the coding parameter determining apparatus may determine a level to which the second partition type belongs, and determine the second partition type, a partition type of a higher level of the level to which the second partition type belongs, and a partition type of a lower level of the level to which the second partition type belongs as the candidate parameter set. That is, the coding parameter determining apparatus may traverse partition types in the candidate parameter set, and determine an optimal partition type in the parameter set as the first partition type.

For example, assuming that the second partition type is 16×16, the coding parameter determining apparatus may determine that the level to which the second partition type belongs is 16. In this case, the coding parameter determining apparatus may determine the second partition type (i.e., 16×16), the partition type (i.e., 32×32) of the higher level of the level to which the second partition type belongs, and the partition type (i.e., 8×8) of the lower level of the level to which the second partition type belongs as the candidate parameter set. That is, the coding parameter determining apparatus may traverse the partition types in the candidate parameter set, and determine an optimal partition type among 16×16, 32×32, and 8×8 as the first partition type.

Certainly, in other embodiments, the partition type of the higher level of the level to which the second partition type belongs may include at least one of 32×32, 16×32, and 32×16, and the partition type of the lower level of the level to which the second partition type belongs may include at least one of 8×8, 16×8, and 8×16, which will not be specifically limited in this application. The candidate parameter set may even further include a partition type of a level lower than the lower level or a partition type of a level higher than the higher level.

The first partition type and the second partition type may be replaced with other parameters having a data format of a×b, which will not be specifically limited in this application. For example, the first partition type may be replaced with a first frame size. The second partition type may also be replaced with a second frame size. For example, the first partition type may be replaced with a first macroblock size. The second partition type may also be replaced with a second macroblock size.

In some embodiments, if the first coding parameter includes a first parameter, a candidate parameter set for the first parameter includes: a plurality of sampled values obtained by sampling within a first value range, where a difference between an upper limit value and a lower limit value of the first value range is equal to a preset threshold, and the value of a parameter in the decoding parameter that has the same parameter type as the first parameter is within the first value range.

Exemplarily, if the value of the parameter in the decoding parameter that has the same parameter type as the first parameter is denoted as a target value, the coding parameter determining apparatus may determine, based on a preset threshold, the first value range using the preset threshold as the difference (which may be a preset numerical value) between the upper limit value and the lower limit value of the first value range, where the target value falls within the first value range, and the coding parameter determining apparatus performs sampling within the first value range, and determines a plurality of sampled values obtained by sampling as a candidate parameter set for the first parameter. That is, the coding parameter determining apparatus may traverse the plurality of sampled values, and determine an optimal value among the plurality of sampled values as the value of the first parameter. Certainly, the coding parameter determining apparatus may also traverse the target value and the plurality of sampled values, and determine an optimal value among the target value and the plurality of sampled values as the value of the first parameter.

For example, assuming that the target value is 16 and a difference between the upper limit value and the lower limit value of the value range of the target value is 3, the coding parameter determining apparatus may determine that the first value range is [15,17]. In this case, the coding parameter determining apparatus may perform sampling with [15,17], and determine a plurality of sampled values (assuming to be 15 and 15.5) obtained by sampling as the candidate parameter set. That is, the coding parameter determining apparatus may traverse 15 and 15.5, and determine an optimal value among 15 and 15.5 as the value of the first parameter. Certainly, the coding parameter determining apparatus may also traverse 16, 15, and 15.5, and determine an optimal value among 16, 15, and 15.5 as the value of the first parameter.

In some embodiments, if the coding parameter includes a first parameter, a candidate parameter set for the first parameter includes a plurality of adjusted values obtained by adjusting a value of a parameter in the decoding parameter that has the same parameter type as the first parameter.

Exemplarily, if the value of a parameter in the decoding parameter that has the same parameter type as the first parameter is denoted as a target value, the coding parameter determining apparatus may adjust, based on a plurality of thresholds, the target value to obtain a plurality of adjusted values, and determine an optimal value among the plurality of adjusted values as the value of the first parameter. Certainly, the coding parameter determining apparatus may also traverse the target value and the plurality of adjusted values, and determine an optimal value among the target value and the plurality of adjusted values as the value of the first parameter.

For example, assuming that the target value is 16 and the plurality of thresholds includes -1 and 1, the coding parameter determining apparatus may determine the plurality of adjusted values as 15 and 17. In this case, the coding parameter determining apparatus may traverse 15 and 17, and determine an optimal value among 15 and 17 as the value of the first parameter. Certainly, the coding parameter determining apparatus may also traverse 16, 15, and 17, and determine an optimal value among 16, 15, and 17 as the value of the first parameter.

The value of the first parameter and the target value may be values of any parameter of which the value is in a numerical format, which will not be specifically limited in this application. For example, the value of the first parameter may be the value of a quantization parameter of the reconstructed picture, and the target value may be the value of a quantization parameter in the decoding information. Alternatively, the value of the first parameter may be the value of a bit rate of the reconstructed picture, and the target value may be the value of a bit rate in the decoding information. Alternatively, the value of the first parameter may be the value of the number of bits occupied by a macroblock of the reconstructed picture in a bit stream, and the target value may be the value of the number of bits occupied by a macroblock in the decoding information in a bit stream. Alternatively, the value of the first parameter may be the value of a motion vector of the reconstructed picture, and the target value may be the value of a motion vector in the decoding information.

In some embodiments, before S430, the method 400 may further include:

determining, by the coding parameter determining apparatus, whether to use the decoding parameter to determine the coding parameter.

Exemplarily, in a case that the coding parameter determining apparatus determines to use the decoding parameter to determine the coding parameter, the coding parameter is determined based on the decoding parameter.

In some embodiments, the determining, by the coding parameter determining apparatus, whether to use the decoding parameter to determine the coding parameter may be implemented as:

evaluating, by the coding parameter determining apparatus, a quality of the reconstructed picture to obtain a quality evaluation value; determining, if the quality evaluation value is greater than or equal to a preset evaluation value, to use the decoding information to determine the coding parameter; and determining, if the quality evaluation value is less than the preset evaluation value, not to use the decoding information to determine the coding parameter.

Exemplarily, before determining the coding parameter of the reconstructed picture, the coding parameter determining apparatus may evaluate a quality of the reconstructed picture. This evaluation process may be based on various quality evaluation indexes, such as a peak signal-to-noise ratio (PSNR) and a structural similarity index measure (SSIM). By evaluation, the apparatus may obtain a quality evaluation value, which is configured for measuring the quality of a reconstructed picture. Next, the apparatus may compare the quality evaluation value with a preset evaluation value. The preset evaluation value may be a threshold, or a value set based on a application scenario or a data type. If the quality evaluation value is greater than or equal to the preset evaluation value, then the apparatus may consider that the decoding information is valid and may be configured for determining the coding parameter. If the quality evaluation value is less than the preset evaluation value, the apparatus may consider that the decoding information is insufficient to determine a coding parameter of high quality. In this case, the apparatus may choose not to use the decoding information to determine the coding parameter, or attempt to use a default computation mode or algorithm to determine the coding parameter.

In this embodiment, whether to use the decoding information to determine the coding parameter is determined by the quality evaluation value. This evaluation mechanism helps ensure that the determined coding parameter may generate a reconstructed picture of high quality, and avoids the adverse impact of low-quality decoding information on the coding parameter. In actual application, a proper evaluation index and a preset evaluation value may be selected according to a requirement and a scenario. In other words, whether to reuse the decoding parameter in the decoding information to determine the coding parameter may be adaptively determined based on the actual requirement on picture quality, thereby facilitating the control on the fluctuation amplitude of computing resources consumed by video coding compression, and also striking a balance between the consumption of computing resources and the coding effect, and further improving the coding performance of a coder.

In some embodiments, the determining, by the coding parameter determining apparatus, whether to use the decoding parameter to determine the coding parameter may be implemented as:

acquiring, by the coding parameter determining apparatus, a first computing capability, where the first computing capability is a computing capability consumed when a coder computes the coding parameter using a default parameter computation mode; determining, based on the first computing capability, whether to use the decoding information to determine the coding parameter.

Exemplarily, before determining the coding parameter of the reconstructed picture, the coding parameter determining apparatus may consider a factor such as a computing capability. In some cases, when a default parameter computation mode is used for a coding parameter, a significant amount of computing capability may be consumed. Therefore, the coding parameter determining apparatus may first acquire a first computing capability, where the first computing capability is a computing capability consumed when a coder computes the coding parameter using a default parameter computation mode. Then, based on the first computing capability, the coding parameter determining apparatus may evaluate the feasibility of determining a coding parameter using the decoding information. For example, the coding parameter determining apparatus may determine, based on a balance between the consumption of a computing capability and the coding performance of the coding parameter, whether to use the decoding information to determine the coding parameter.

In this embodiment, whether to use the decoding information to determine the coding parameter is determined by the first computing capability. This manner of considering a computing capability helps balance the accuracy of the coding parameter and a consumed computing capability. In some application scenarios, a coding parameter may be determined as accurately as possible with limited computing resources. By evaluating a first computing capability, the coding parameter determining apparatus may better balance different factors and make a decision about whether to use the decoding information to determine the coding parameter.

In some embodiments, the determining, based on the first computing capability, whether to use the decoding information to determine the coding parameter may be implemented as:

determining, if the first computing capability is greater than or equal to a computing capability provided by an idle computing resource of a coder, to use the decoding information to determine the coding parameter; or determining, if the first computing capability is less than the computing capability provided by the idle computing resource, not to use the decoding information to determine the coding parameter.

In some cases, the coding parameter determining apparatus may be limited by a computing capability. In this case, the coding parameter determining apparatus may acquire, as a reference, the computing capability provided by the idle computing resource of the coder. If the first computing capability is greater than or equal to the computing capability provided by the idle computing resource, it indicates that a significant amount of computing capability may be consumed when a default parameter computing mode is used for the coding parameter. In this case, the computation of the coding parameter using the decoding information may not exceed available computing resources, thereby guaranteeing the smooth progress of the computation. However, if the first computing capability is less than the computing capability provided by the idle computing resources, then the coding parameter determining apparatus computes the coding parameter using the default parameter computation mode, such that not only the capability provided by the idle computing resources is not exceeded, but also the accuracy of the coding parameter may be guaranteed, for example, it is determined not to use the decoding information to determine the coding parameter.

In this embodiment, by comparing the first computing capability with the capability provided by the idle computing resource, the coding parameter determining apparatus may better evaluate the feasibility of determining the coding parameter using decoding information, thereby balancing the accuracy of the decoding information and the consumption of the computing capability with limited computing resources, so as to adapt to different scenarios and requirements. In other words, whether to reuse the decoding parameter in the decoding information to determine the coding parameter may be adaptively determined based on the actual requirement of the default parameter computation mode on the computing capability, thereby facilitating the control on the fluctuation amplitude of computing resources consumed by video coding compression, and also striking a balance between the consumption of computing resources and the coding effect, and further improving the coding performance of a coder.

In some embodiments, the determining, based on the first computing capability, whether to use the decoding information to determine the coding parameter may be implemented as:

acquiring a first resource utilization of the coder; converting the first computing capability into a used computing resource of the coder, and adjusting, based on the used computing resource, the first resource utilization to obtain a second resource utilization; determining, if the second resource utilization is greater than or equal to a preset resource utilization, to use the decoding information to determine the coding parameter; and determining, if the second resource utilization is less than the preset resource utilization, not to use the decoding information to determine the coding parameter.

Exemplarily, the coding parameter determining apparatus acquires the first resource utilization of the coder, where the first resource utilization represents the resource occupation of the coder when executing a coding operation. The resource occupation may include CPU utilization, memory usage, magnetic disk input/output (I/O), and the like. The coding parameter determining apparatus converts the first computing capability into a used computing resource of the coder. This may be implemented by comparing the first computing capability with the total computing capability of the coder. For example, if the first computing capability is 30%, it may be considered that the coder has used 30% of the computing resources. Next, the coding parameter determining apparatus adjusts, based on the used computing resource, the first resource utilization: adjusts, based on the used computing resource, the first resource utilization to obtain a second resource utilization. This may be implemented by adding the used computing resource and the first resource utilization to obtain the second resource utilization. For example, if 30% of the computing resources have been used, and the first resource utilization is 50%, the second resource utilization is 80%. Therefore, the coding parameter determining apparatus may compare the second resource utilization with the preset resource utilization. If the second resource utilization is greater than or equal to the preset resource utilization, it may be considered that if the coding parameter is computed using a default computation mode, the excessively high resource utilization of the coder may be caused. That is, it is determined not to use the default computation mode to compute the coding parameter. In other words, the coding parameter determining apparatus determines to use the decoding information to determine the coding parameter.

If the second resource utilization is less than the preset resource utilization, it may be considered that if the coding parameter is computed using the default computation mode, the excessively high resource utilization of the coder cannot be caused, and the accuracy of the coding parameter may be guaranteed. That is, the coding parameter may be computed using the default computation mode. In other words, the coding parameter determining apparatus determines not to use the decoding information to determine the coding parameter.

In this embodiment, by acquiring the first resource utilization of the coder, and converting the first computing capability into the used computing resource, and adjusting the first resource utilization, a more accurate second resource utilization may be obtained. This facilitates a better evaluation of the resource usage of the coder when it is assumed that the coding parameter is computed using a default parameter computation mode, thereby effectively making a decision about whether to use the decoding information to determine the coding parameter. In other words, whether to reuse the decoding parameter in the decoding information to determine the coding parameter may be adaptively determined based on the actual requirement on resource utilization, thereby facilitating the control on the fluctuation amplitude of computing resources consumed by video coding compression, and also striking a balance between the consumption of computing resources and the coding effect, and further improving the coding performance of a coder.

In some embodiments, the determining, by the coding parameter determining apparatus, whether to use the decoding parameter to determine the coding parameter may be implemented as:

acquiring a first performance parameter, where the first performance parameter is a performance parameter of the coder when the coder determines the coding parameter using the decoding parameter; determining, if the first performance parameter meets a performance parameter required by a service scenario, to use the decoding information to determine the coding parameter; and determining, if the first performance parameter does not meet the performance parameter required by the service scenario, not to use the decoding information to determine the coding parameter.

Exemplarily, the service scenario may include any one of the following: a scenario with low latency and a high (frame output) stability requirement (for example, an RTC scenario), a scenario with low latency requirement (for example, Web RTC), a scenario considering both costs and (frame output) stability (for example, HLS/DASH live streaming), a cost-prioritized scenario (an on-demand scenario), and the like.

Exemplarily, the coding parameter determining apparatus may acquire the first performance parameter, where the first performance parameter represents the performance of the coder when computing the coding parameter using a default parameter computation mode. The performance parameters may include indicators such as delay, the stability of an output picture, and resource costs. Next, the coding parameter determining apparatus will compare the first performance parameter with the performance parameter required by the service scenario. The performance parameters required by the service scenario may be determined according to the requirement of actual application, for example, indicators such as delay, the stability of an output picture, and resource costs. The parameter type of the performance parameter required by the service scenario may be the same as or different from that of the first performance parameter. The performance parameter required by the service scenario and the first performance parameter need to be mapped to the same mapping space and compared when they are different. If the first performance parameter meets the performance parameter required by the service scenario, for example, the performance of the coder meets the requirement of the actual application, then the coding parameter determining apparatus may consider that it is feasible to determine the coding parameter using the decoding information. However, if the first performance parameter does not meet the performance parameter required by the service scenario, for example, the performance of the coder does not meet the requirement of the actual application, then the coding parameter determining apparatus may consider that it is not feasible or cost-effective to determine the coding parameter using the decoding information. In this case, even if the decoding information helps reduce the computation complexity of the coding parameter, the performance requirement of the actual application may not be met, and therefore it is not worth to use the decoding information.

In this embodiment, by evaluating a matching degree between the first performance parameter and the performance parameter required by the service scenario, the coding parameter determining apparatus may better balance the computation complexity of the coding parameter and the performance requirement of the actual application, so as to adapt to different scenarios and requirements. In other words, whether to reuse the decoding parameter in the decoding information to determine the coding parameter may be adaptively determined based on the performance parameter required by the service scenario, thereby facilitating the control on the fluctuation amplitude of computing resources consumed by video coding compression, and also striking a balance between the consumption of computing resources and the coding effect, and further improving the coding performance of a coder.

Certainly, in other embodiments, if the first performance parameter is a performance parameter of the coder when the coder determines the coding parameter using a default parameter computation mode: if the first performance parameter meets a performance parameter required by a service scenario, it is determined not to use the decoding information to determine the coding parameter; and if the first performance parameter does not meet the performance parameter required by the service scenario, it is determined to use the decoding information to determine the coding parameter.

Only one factor among the quality evaluation value, the first computing capability, and the first performance parameter above may be considered, or multiple factors among them may be considered. The implementations may vary depending on application scenarios and requirements, and even other factors may be considered, which will not be specifically limited in this application.

For example, after acquiring the decoding information and data of a reconstructed picture, for example, Luma-Chroma (YCbCr, YUV) information, the coding parameter determining apparatus may determine the coding parameter of the reconstructed picture according to the picture quality of the reconstructed picture, idle computing resources of a coder, computation costs, and control whether to reuse the decoding parameter in the decoding information, so as to smoothly control the coding performance and resource consumption of the coding parameter. Therefore, in a case of a loss in BD-rate, it can be guaranteed that the consumption of the computing resources is smoothly controlled. For example, tests show that the computing resource load of the coder may be increased by 5 to 10 points, thereby reducing the video media processing and transcoding costs, and facilitating the reduction of costs and the improvement of efficiency in media processing and transcoding, especially in scenarios such as video media processing and live streaming.

For another example, in other alternative embodiments, other factors (such as the reliability of the decoding information and the real-time requirement) may also be considered to determine whether to use the decoding information to determine the coding parameter of the reconstructed picture.

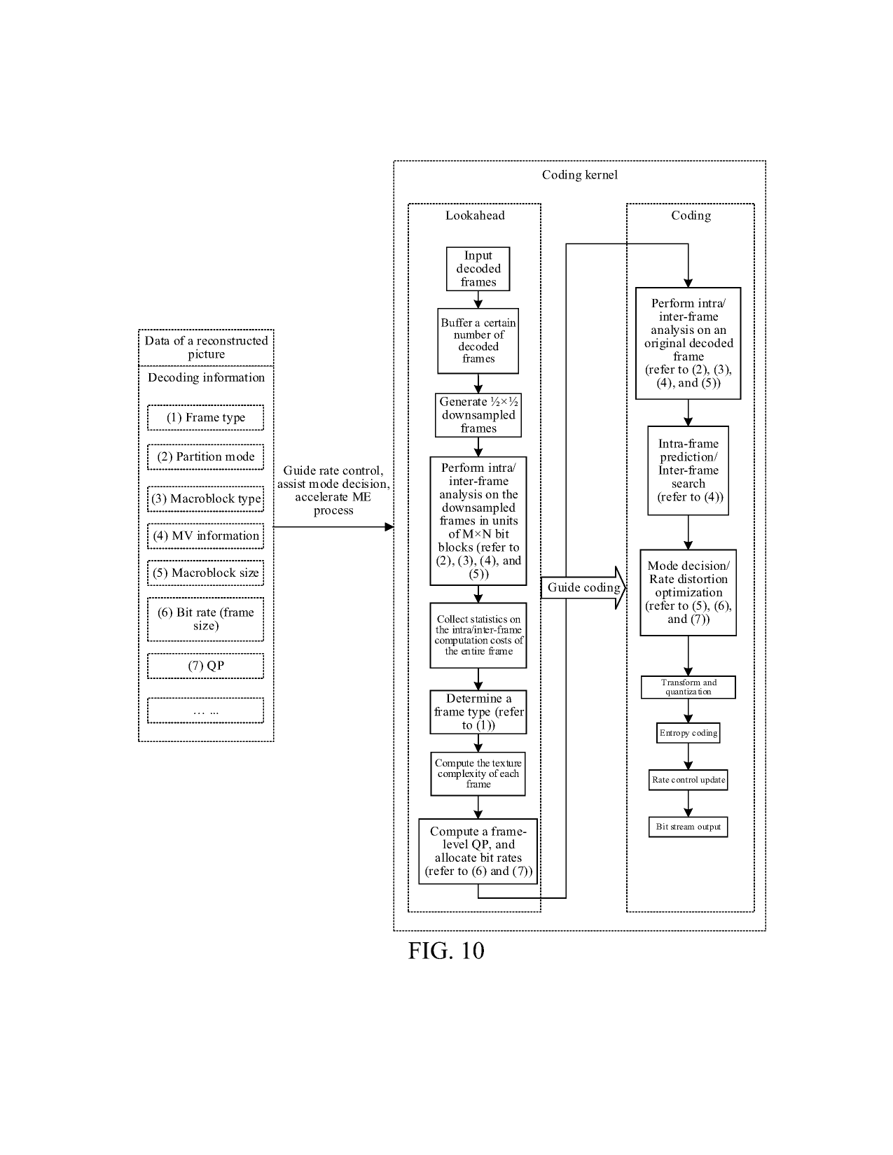

FIG. 10 is a schematic diagram of using a decoding parameter in a coding kernel according to some embodiments.

As shown in FIG. 10, after acquiring data and decoding information of a decoded picture, the coding parameter determining apparatus may apply information in the decoding information to a coding parameter that may be determined in the lookahead process and the coding process executed by the coding kernel.

The decoding information may include the following information: (1) frame type, (2) partition type, (3) macroblock type, (4) motion vector, (5) macroblock size, (6) bit rate, and (7) quantization parameter.

For the lookahead process, it may include: acquiring decoded frames and buffering a certain number of decoded frames, then generating ½×½ downsampled frames, and performing intra/inter-frame analysis (for example, partition types of CU, PU, and TU and corresponding prediction modes) on the downsampled frames in units of M×N bit blocks; next, collecting statistics on the intra/inter-frame computation costs of the entire frame, and determining a frame type; next, computing the texture complexity of each frame, computing a frame-level QP, and allocating bit rates.

The process that consumes most computing resources in the lookahead process includes: a process of performing the intra/inter-frame analysis on the downsampled frame in units of M×N bit blocks. The coding parameters determined in the lookahead include parameters such as partition type and motion vector. When determining the coding parameter, reference may be made to (2) to (5) in the decoding information. For example, whether to refer to information in (2) to (5) may be determined according to the requirement of an application scenario on latency and the consumption of computing resources. For example, referring to (4), the motion vector may be used as a starting search point of a search process, such that the search process may be greatly accelerated, and a found optimal MV is used as an MV used when coding a current decoded picture, thereby improving the accuracy in controlling the transcoding speed and the bit rate.

In addition, for the process of determining a frame type in the lookahead process, considering that the consumption of the computing resources is relatively high during decision-making of an I-frame/a P-frame/a B-frame, for example, B/P is decided by the cost of coding into the B-frame and the cost of coding into the P-frame. Moreover, since frame-by-frame forward processing may be required, the computing resource consumption almost increase multiplicatively. In this embodiment, whether to refer to (1) may be determined according to a comprehensive evaluation of the application scenario latency and the consumption of the computing resources, so as to determine a frame type used in coding a current decoded frame, thereby reducing the consumed computing resources. For frame-level QP computation and bit rate allocation in the lookahead process, whether to refer to (5) to (7) may be determined according to a comprehensive evaluation of the application scenario latency and the consumption of the computing resources, so as to determine a bit rate and a frame-level QP used in coding a current decoded frame, thereby reducing the consumed computing resources.

For the coding process, it may include: performing intra/inter-frame analysis (for example, partition types of CU, PU, and TU and corresponding prediction modes) on an original decoded frame, then performing intra-frame prediction/inter-frame search, then performing mode decision/rate distortion optimization, and finally performing transform, quantization, entropy coding, rate control update, and bit stream output. For information that may be referenced during the coding process, it is similar to that in the lookahead process. Specifically, whether to refer to (2) to (5) may be considered in the intra/inter-frame analysis, whether to refer to (4) may be considered in the intra-frame prediction/inter-frame search process, and whether to refer to (5) to (7) may be considered in the mode decision/rate distortion optimization process. In this way, a bit rate and a frame-level QP used in coding a current decoded frame are determined, thereby reducing the consumed computing resources.

In this embodiment, by referring to the decoding information in the process with the relatively high computing resource consumption in the lookahead process and the coding process, in a case of a loss in BD-rate, it can be guaranteed that the consumption of the computing resources is smoothly controlled. For example, tests show that the computing resource load of the coder may be increased by 5 to 10 points, thereby reducing the video media processing and transcoding costs, and facilitating the reduction of costs and the improvement of efficiency in media processing and transcoding, especially in scenarios such as video media processing and live streaming.

Preferred implementations of this application are described in detail above with reference to the accompanying drawings. However, this application is not limited to the details in the foregoing implementations. In the scope of the technical idea of this application, many simple variations can be made to the technical solutions of this application, and the simple variations all fall within the protection scope of this application. For example, the technical features described in the above implementations may be combined in any proper manner in case of no contradiction. To avoid unnecessary repetition, possible combinations are not described in this application. For another example, different implementations of this application may also be combined in different manners without departing from the idea of this application, and these combinations shall still be regarded as content disclosed in this application.

The sequence numbers of the processes in the method embodiments of this application do not indicate execution sequences. The execution sequences of the processes are determined based on functions and internal logic of the processes, and are not construed as any limitation on the implementation processes of some embodiments.

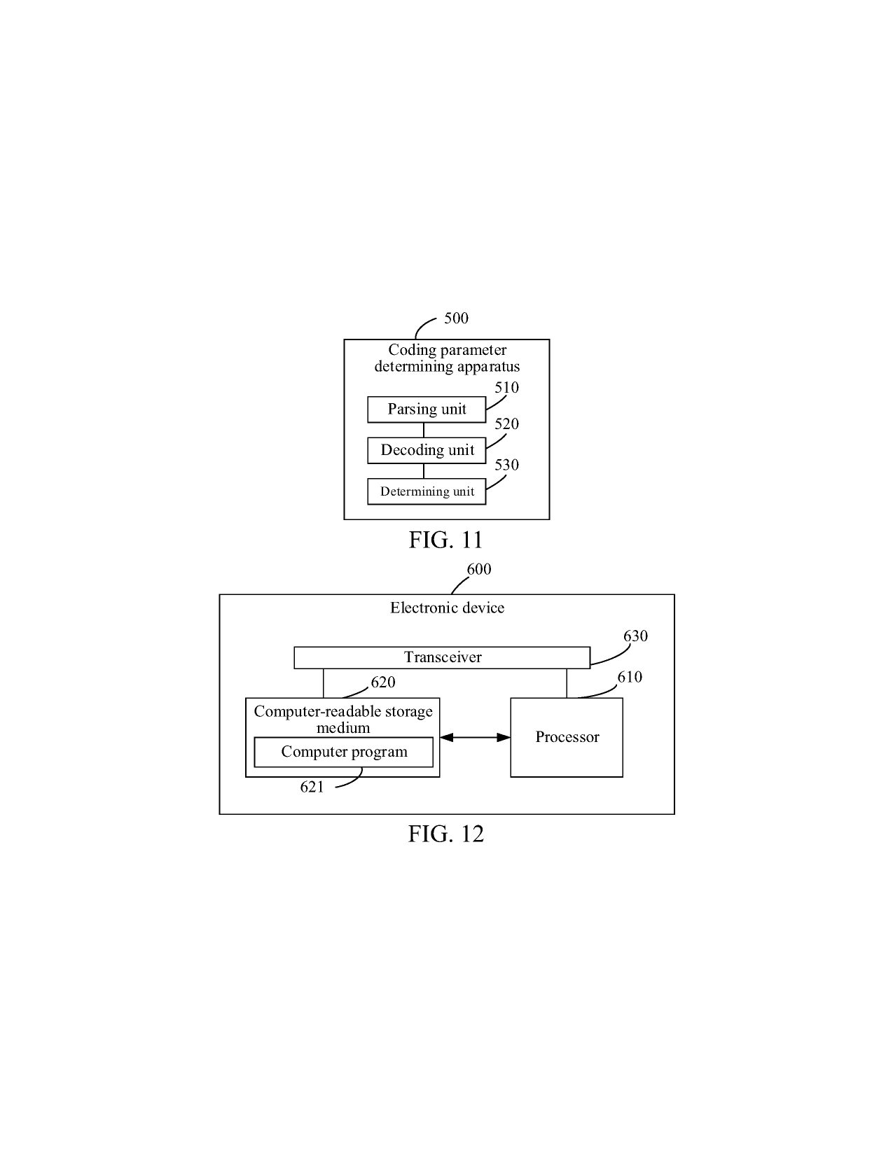

An apparatus embodiment of this application will be described in detail with reference to FIG. 11 to FIG. 12.

FIG. 11 is a schematic block diagram of a coding parameter determining apparatus 500 according to this application.

As shown in FIG. 11, the coding parameter determining apparatus 500 may include:

a parsing unit 510, configured to parse a bit stream to obtain a to-be-decoded picture and decoding information;

a decoding unit 520, configured to decode the to-be-decoded picture using the decoding information to obtain a reconstructed picture; and

a determining unit 530, configured to determine, based on a decoding parameter in the decoding information, a coding parameter configured for recoding the reconstructed picture.

In some embodiments, before determining a coding parameter used for recoding the reconstructed picture, the determining unit 530 is further configured to:

determining, as the decoding parameter, a parameter in the decoding information that has the same parameter type as the coding parameter.

In some embodiments, the determining unit 530 is specifically configured to:

determine the decoding parameter as the coding parameter.

In some embodiments, the determining unit 530 is specifically configured to:

determine, based on the decoding parameter, the coding parameter using a parameter computation mode matching a parameter type of the coding parameter.

In some embodiments, if the coding parameter includes a first motion vector, the parameter computation mode matching the parameter type of the coding parameter includes a parameter computation mode matching a motion vector, and the parameter computation mode matching the motion vector includes at least one of the following:

a first search mode in which search is performed with a motion vector in the decoding parameter taken as a starting search point;

a second search mode in which search is performed with higher precision than a precision of the motion vector in the decoding parameter; and

a third search mode in which a search range is smaller than a search range used in a default computation mode of the motion vector.

In some embodiments, the determining unit 530 is specifically configured to:

determine, based on the decoding parameter, a candidate parameter set for the coding parameter; and

traverse parameters in the candidate parameter set, and determine an optimal parameter in the candidate parameter set as the coding parameter.

In some embodiments, if the coding parameter includes a first partition type, the candidate parameter set for the first partition type includes: a partition type in the decoding parameter, a partition type of a higher level of a level to which the partition type in the decoding parameter belongs, and a partition type of a lower level of the level to which the partition type in the decoding parameter belongs.

In some embodiments, if the coding parameter includes a first parameter, a candidate parameter set for the first parameter includes: a plurality of sampled values obtained by sampling within a first value range, or a plurality of adjusted values obtained by adjusting a value of a parameter in the decoding parameter that has the same parameter type as the first parameter, where a difference between an upper limit value and a lower limit value of the first value range is equal to a preset threshold, and the value of a parameter in the decoding parameter that has the same parameter type as the first parameter is within the first value range.

In some embodiments, before determining a coding parameter used for recoding the reconstructed picture, the determining unit 530 is further configured to:

determine whether to use the decoding parameter to determine the coding parameter.

In some embodiments, the determining unit 530 is specifically configured to:

evaluate a quality of the reconstructed picture to obtain a quality evaluation value;

determine, if the quality evaluation value is greater than or equal to a preset evaluation value, to use the decoding parameter to determine the coding parameter; and

determine, if the quality evaluation value is less than the preset evaluation value, not to use the decoding parameter to determine the coding parameter.

In some embodiments, the determining unit 530 is specifically configured to:

acquire a first computing capability, where the first computing capability is a computing capability consumed when a coder computes the coding parameter using a default parameter computation mode;

determine, based on the first computing capability, whether to use the decoding parameter to determine the coding parameter.

In some embodiments, the determining unit 530 is specifically configured to:

determine, if the first computing capability is greater than or equal to a computing capability provided by an idle computing resource of the coder, to use the decoding parameter to determine the coding parameter; and

determine, if the first computing capability is less than the computing capability provided by the idle computing resource, not to use the decoding parameter to determine the coding parameter.

In some embodiments, the determining unit 530 is specifically configured to:

acquire a first resource utilization of the coder;

convert the first computing capability into a used computing resource of the coder, and adjust, based on the used computing resource, the first resource utilization to obtain a second resource utilization;

determine, if the second resource utilization is greater than or equal to a preset resource utilization, to use the decoding parameter to determine the coding parameter; and

determine, if the second resource utilization is less than the preset resource utilization, not to use the decoding parameter to determine the coding parameter.

In some embodiments, the determining unit 530 is specifically configured to:

acquire a first performance parameter, where the first performance parameter is a performance parameter of the coder when the coder determines the coding parameter using the decoding parameter;

determine, if the first performance parameter meets a performance parameter required by a service scenario, to use the decoding parameter to determine the coding parameter; and

determine, if the first performance parameter does not meet the performance parameter required by the service scenario, not to use the decoding parameter to determine the coding parameter.

In some embodiments, the decoding information includes at least one of the following: picture type, partition type, macroblock type, motion vector, macroblock size, bit rate, quantization parameter, and the number of bits occupied by a macroblock in a bit stream.

Apparatus embodiments and method embodiments may correspond to each other. For a similar description, reference may be made to the method embodiments. To avoid repetition, . Specifically, the apparatus 500 shown in FIG. 11 may correspond to a corresponding entity executing the method 400 in some embodiments, and the foregoing and other operations and/or functions of units in the apparatus 500 are respectively intended to implement corresponding processes in the method 400.

The units in the apparatus 500 in some embodiments are partitioned based on logical functions. In actual application, functions of one unit may be implemented by a plurality of units, functions of a plurality of units may be implemented by one unit, or even these functions may be implemented with the assistance of one or more other units. For example, part or all of the units in the apparatus 500 are merged into one or several additional units. For another example, one or more unit (s) in the apparatus 500 may be further divided into a plurality of functionally smaller units. This may implement same the operations, without affecting the implementation of the technical effects of some embodiments. For another example, the apparatus 500 may also include other units. In actual application, these functions may also be implemented with the assistance of other units, and may be implemented with the assistance of a plurality of units.

According to another embodiment of this application, the apparatus 500 in some embodiments may be constructed, and the coding parameter determining method in some embodiments may be implemented by running a computer program (including program codes) that is capable of executing the operations of the corresponding methods in a general-purpose computer device such as a general-purpose computer including processing elements and storage elements such as a central processing unit (CPU), a random access memory (RAM), and a read-only memory (ROM). The computer program may be recorded in, for example, a computer-readable storage medium, and loaded into an electronic device via the computer-readable storage medium, such that the corresponding method of the embodiment of this application is executed when the computer program runs in the electronic device.

In other words, the units above may be implemented in hardware, or may be implemented in software, or may be implemented in a combination of the software and the hardware.

Specifically, the operations of the method embodiments in some embodiments may be completed by instructions in the form of hardware integrated logic circuits and/or software in the processor, and operations of the methods disclosed with reference to some embodiments may be directly executed and completed using a hardware decoding processor, or may be executed and completed using a combination of hardware and software modules in the decoding processor. In some embodiments, the software module may be located in a mature storage medium in the art, such as a random access memory, a flash memory, a read-only memory, a programmable read-only memory, an electrically-erasable programmable memory, and a register. The processor reads information in the memory and completes the operations of the method embodiments above in combination with hardware of the processor.

FIG. 12 is a schematic structural diagram of an electronic device 600 according to this application.

As shown in FIG. 12, the electronic device 600 includes at least a processor 610 and a computer-readable storage medium 620. The processor 610 and the computer-readable storage medium 620 may be connected by a bus or in another manner. The computer-readable storage medium 620 is configured to store a computer program 621. The computer program 621 includes computer instructions. The processor 610 is configured to execute the computer instructions stored in the computer-readable storage medium 620. The processor 610 is a computing core and a control core of the electronic device 600. The processor is adapted to implement one or more computer instructions. Specifically, the processor is adapted to load and execute one or more computer instructions, thereby implementing corresponding method processes or corresponding functions.

Exemplarily, the processor 610 may also be referred to as a central processing unit (CPU). The processor 610 may include, but is not limited to: a general-purpose processor, a digital signal processor (DSP), an application integrated circuit (ASIC), a field programmable gate array (FPGA) or other programmable logic devices, a transistor logic device, or a discrete hardware component.

Exemplarily, the computer-readable storage medium 620 may be a high-speed RAM memory, or may be a non-volatile memory, for example, at least one magnetic disk memory. In some embodiments, the computer-readable storage medium may be at least one computer-readable storage medium located away from the foregoing processor 610. Specifically, the computer-readable storage medium 620 includes, but is not limited to, a volatile memory and/or a non-volatile memory. The non-volatile memory may be a ROM, a PROM, an erasable programmable read-only memory (EPROM), an electrically erasable programmable read-only memory (EEPROM), or a flash memory. The volatile memory may be a random access memory (RAM), which is used as an external high-speed cache. Through illustrative but not limited description, RAMs in many forms, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM), are available.

As shown in FIG. 12, the electronic device 600 may further include a transceiver 630.

The processor 610 may control the transceiver 630 to communicate with other devices, and specifically, may transmit information or data to the other devices or receive information or data transmitted by the other devices. The transceiver 630 may include a transmitter and a receiver. The transceiver 630 may further include an antenna, and a quantity of the antenna may be one or more.

Exemplarily, the electronic device 600 may be the coding parameter determining apparatus according to some embodiments. The computer-readable storage medium 620 stores computer instructions. The processor 610 loads and executes the computer instructions stored in the computer-readable storage medium 620, so as to implement corresponding operations in the coding parameter determining method provided in this application. In other words, the computer instructions in the computer-readable storage medium 620 are loaded by the processor 610 to execute the corresponding operations. To avoid repetition.

For example, the coding parameter determining apparatus in some embodiments may be a coder.

According to another aspect of this application, this application further provides a coding and decoding system, including the coder and the decoder mentioned above.

According to another aspect of this application, this application further provides a computer-readable storage medium (memory). The computer-readable storage medium stores computer instructions which, read and executed by a processor of a computer device, cause the computer device to execute the coding parameter determining method mentioned above.

The computer-readable storage medium is a storage device in the decoder or coder, which is configured to store programs and data. The computer-readable storage medium herein may include an internal storage medium of the electronic device, and certainly may also include an expanded storage medium supported by the electronic device. The computer-readable storage medium may be configured to provide a storage space. The storage space may store an operating system of the electronic device. In addition, one or more computer instructions suitable for being loaded and executed by the processor are further stored in the storage space. For example, one or more computer instructions configured for executing the coding parameter determining method mentioned above are stored. These computer instructions may be one or more computer programs (including program codes).

According to another aspect of this application, a computer program product or a computer program is provided. The computer program product or the computer program includes computer instructions, and the computer instructions are stored in a computer-readable storage medium. A processor of a computer device reads the computer instructions from the computer-readable storage medium. The processor executes the computer instructions to cause the computer to execute the coding parameter determining method provided in the various alternatives mentioned above.

The computer device in this application may be any device or apparatus capable of performing data processing, for example, the computer device includes, but is not limited to: a general-purpose computer, a special-purpose computer, a computer network, or other programmable apparatuses. In addition, the computer instructions in this application may be stored in the computer-readable storage medium, or may be transmitted between a computer-readable storage medium and another computer-readable storage medium. For example, the computer instructions may be transmitted from a website, a computer, a server, or a data center to another website, computer, server, or data center in a wired manner (for example, through a coaxial cable, an optical fiber, or a digital subscriber line (DSL)) or a wireless manner (for example, in an infrared, radio, or microwave manner).

According to another aspect of this application, this application further provides a bit stream, where the bit stream may be a bit stream generated using the coding parameter determining method provided in this application.

A person of skill in the art may be aware that, in combination with the examples described in embodiments disclosed in this specification, units and methods may be implemented by electronic hardware or a combination of computer software and electronic hardware. Whether the functions are executed in a mode of hardware or software depends on applications and design constraint conditions of the technical solutions. Those skilled in the art may use different methods to implement the described functions for each application, but such implementation is not to be considered beyond the scope of this application.

Finally, the above content is merely implementations of this application, but is not intended to limit the protection scope of this application. Any person skilled in the art can easily conceive of alterations or replacements within the technical scope disclosed in this application. All these alterations or replacements are encompassed within the scope of protection of this application. Therefore, the protection scope of this application is subject to the protection scope of the claims.

What is claimed is:

1. A coding parameter determining method, performed by a computer device, and the method comprising:
parsing a bit stream to obtain a coded picture and decoding information;
decoding the coded picture using the decoding information to obtain a reconstructed picture;
determining, based on a decoding parameter in the decoding information, a coding parameter for recoding the reconstructed picture; And
recoding the reconstructed picture based on the coding parameter to generate a recoded bit stream.

2. The method according to claim 1, wherein before the determining the coding parameter, the method further comprises:
determining, as the decoding parameter, a parameter in the decoding information that has the same parameter type as the coding parameter.

3. The method according to claim 1, wherein the determining the coding parameter comprises:
determining the decoding parameter as the coding parameter.

4. The method according to claim 1, wherein the determining the coding parameter comprises:
determining, based on the decoding parameter, the coding parameter using a parameter computation mode matching a parameter type of the coding parameter.

5. The method according to claim 4, wherein, based on the coding parameter comprising a first motion vector, the parameter computation mode comprises at least one of the following:
a first search mode that uses a motion vector in the decoding parameter as a starting search point;
a second search mode in which search is performed at a higher precision than a precision of the motion vector in the decoding parameter; or
a third search mode that uses a search range smaller than a search range used in a default computation mode of the motion vector.

6. The method according to claim 1, wherein the determining the coding parameter comprises:
determining, based on the decoding parameter, a candidate parameter set for the coding parameter; and
traversing parameters in the candidate parameter set, and determining an optimal parameter as the coding parameter.

7. The method according to claim 6, wherein, based on the coding parameter comprising a first partition type, the candidate parameter set for the first partition type comprises: a second partition type in the decoding parameter, a partition type of a higher level of a level to which the second partition type belongs, and a partition type of a lower level of the level to which the second partition type belongs.

8. The method according to claim 6, wherein, based on the coding parameter comprising a first parameter, the candidate parameter set for the first parameter comprises: a plurality of sampled values obtained by sampling within a first value range, or a plurality of adjusted values obtained by adjusting a value of a matching parameter in the decoding parameter that has the same parameter type as the first parameter,
wherein a difference between an upper limit value and a lower limit value of the first value range is equal to a preset threshold, and the value of the matching parameter is within the first value range.

9. The method according to claim 1, wherein before the determining the coding parameter, the method further comprises:
determining whether to use the decoding parameter to determine the coding parameter.

10. The method according to claim 9, wherein the determining whether to use the decoding parameter comprises:
evaluating a quality of the reconstructed picture to obtain a quality evaluation value;
based on the quality evaluation value being greater than or equal to a preset evaluation value, determining to use the decoding parameter to determine the coding parameter; and
based on the quality evaluation value being less than the preset evaluation value, determining not to use the decoding parameter to determine the coding parameter.

11. The method according to claim 9, wherein the determining whether to use the decoding parameter comprises:
acquiring a first computing capability, wherein the first computing capability is a computing capability consumed when a coder computes the coding parameter using a default parameter computation mode;
determining, based on the first computing capability, whether to use the decoding parameter to determine the coding parameter.

12. The method according to claim 11, wherein the determining, based on the first computing capability, whether to use the decoding parameter comprises:
based on the first computing capability being greater than or equal to a computing capability provided by an idle computing resource of the coder, determining to use the decoding parameter to determine the coding parameter; and
based on the first computing capability being less than the computing capability provided by the idle computing resource, determining not to use the decoding parameter to determine the coding parameter.

13. The method according to claim 11, wherein the determining, based on the first computing capability, whether to use the decoding parameter comprises:
acquiring a first resource utilization of the coder;
converting the first computing capability into a used computing resource of the coder, and adjusting, based on the used computing resource, the first resource utilization to obtain a second resource utilization;
based on the second resource utilization being greater than or equal to a preset resource utilization, determining to use the decoding parameter to determine the coding parameter; and
based on the second resource utilization being less than the preset resource utilization, determining not to use the decoding parameter to determine the coding parameter.

14. The method according to claim 9, wherein the determining whether to use the decoding parameter comprises:
acquiring a first performance parameter, the first performance parameter being a performance parameter of the coder when determining the coding parameter using the decoding parameter;
based on the first performance parameter meeting a performance parameter required by a service scenario, determining to use the decoding parameter to determine the coding parameter; and
based on the first performance parameter not meeting the performance parameter required by the service scenario, determining not to use the decoding parameter to determine the coding parameter.

15. A coding parameter determining apparatus, comprising:
at least one memory configured to store program code; and
at least one processor configured to read the program code and operate as instructed by the program code, the program code comprising:
parsing code configured to cause at least one of the at least one processor to parse a bit stream to obtain a coded picture and decoding information;
decoding code configured to cause at least one of the at least one processor to decode the coded picture using the decoding information to obtain a reconstructed picture;
determining code configured to cause at least one of the at least one processor to determine, based on a decoding parameter in the decoding information, a coding parameter for recoding the reconstructed picture; and
recoding code configured to cause at least one of the at least one processor to recode the reconstructed picture based on the coding parameter to generate a recoded bit stream.

16. The apparatus according to claim 15, wherein the program code further comprises:
parameter code configured to cause at least one of the at least one processor to determine, as the decoding parameter, a parameter in the decoding information that has the same parameter type as the coding parameter.

17. The apparatus according to claim 15, wherein the determining code is further configured to cause at least one of the at least one processor to:
determine the decoding parameter as the coding parameter.

18. The apparatus according to claim 15, wherein the determining code is further configured to cause at least one of the at least one processor to:
determine, based on the decoding parameter, the coding parameter using a parameter computation mode matching a parameter type of the coding parameter.

19. The apparatus according to claim 18, wherein, based on the coding parameter comprising a first motion vector, the parameter computation mode comprises at least one of the following:
a first search mode that uses a motion vector in the decoding parameter as a starting search point;
a second search mode in which search is performed at a higher precision than a precision of the motion vector in the decoding parameter; or
a third search mode that uses a search range smaller than a search range used in a default computation mode of the motion vector.

20. A non-transitory computer-readable storage medium, storing computer code which, when executed by at least one processor, causes the at least one processor to at least:
parse a bit stream to obtain a coded picture and decoding information;
decode the coded picture using the decoding information to obtain a reconstructed picture;
determine, based on a decoding parameter in the decoding information, a coding parameter for recoding the reconstructed picture; and
recode the reconstructed picture based on the coding parameter to generate a recoded bit stream.
